(19) United States
(12) Patent Application Publication
(10) Pub. No.: US 2013/0090763 A1
(43) Pub. Date: Apr. 11, 2013

(54) SYSTEMS AND METHODS FOR FORCE SENSING IN A ROBOT

(71) Applicants: Nabil Simaan, Nashville, TN (US); Kai Xu, New York, NY (US)

(72) Inventors: Nabil Simaan, Nashville, TN (US); Kai Xu, New York, NY (US)

(73) Assignee: THE TRUSTEES OF COLUMIBIA UNIVERSITY IN THE CITY OF THE CITY OF NEW YORK, NEW YORK (NY)

(21) Appl. No.: 12/811,504

(22) PCT Filed: Jan. 26, 2009
(86) PCT No.: PCT/US09/32068

§ 371 Date: Aug. 26, 2010

Related U.S. Application Data
(60) Provisional application No. 61/023,805, filed on Jan. 25, 2008.
(60) Provisional application No. 61/042,032, filed on Apr. 3, 2008.

(51) Int. Cl. B25J 19/02

(52) U.S. Cl. CPC B25J 19/02; B25J 19/025
USPC 700/258

(57) ABSTRACT

A system for force sensing in a robot is provided. The robot includes an end disk and a plurality of backbones coupled to the end disk. A plurality of spacer disks are dispersed along the plurality of backbones, and keep the plurality of backbones separated from one another. A base disk provides an interconnection point to a lumen, and the lumen provides a channel to an actuation device. The actuation device provides actuation of the backbones. At least one sensor measures the force being applied on one of the plurality of backbones, and a processor receives force measurements from the at least one sensor and determines the displacement of at least one of the plurality of backbones.

### CROSS-REFERENCE TO RELATED APPLICATIONS

This application claims benefit under 35 U.S.C. §119(e) of U.S. Provisional Patent Application Nos. 61/023,805, entitled “Systems and Methods for Force Sensing using Continuum Robots,” filed Jan. 25, 2008, 61/042,032, entitled “Force Sensing of Continuum Robot,” filed Apr. 3, 2008, and 61/147,275, entitled “System and Method for Intrinsic Force Sensing and Its Performance Index of Multi-Segment Robots,” filed Jan. 26, 2009, the entireties of which are explicitly incorporated by reference herein.

### STATEMENT REGARDING FEDERALLY-SPONSORED RESEARCH OR DEVELOPMENT

This invention was made with government support under Engineering Research Center grant #EEC9731478 and NSF grant #IIS9801684 awarded by the National Science Foundation (NSF) and under grant #R21 EB004457-01 awarded by the National Institutes of Health (NIH). The government has certain rights in the invention.

### BACKGROUND

In conventional surgery, a doctor has to cut openings in a patient large enough to allow visualization of and manual access to the surgical site. In the past two decades, medical surgery has steadily advanced to include Minimally Invasive Surgery (MIS), which includes surgical techniques that are less invasive than conventional open surgery. A minimally invasive procedure typically involves the insertion of devices and manual or remote-control manipulation of instruments through small incisions in a patient's body. Typically, the physician views the surgical field through an endoscope or other vision device that is inserted through a small incision in the patient's body. Minimally invasive surgery can result in less pain and scarring, can speed recovery, and can reduce the incidence of post-surgical complications.

Minimally invasive surgery involving manual surgical tool manipulation entails the surgeon manipulating long, slender, rigid tools outside the surgical site. This presents the problem of limited motion of the tools within the body of the patient and prevents certain type of surgeries from being performed due to the deficiencies in dexterity of the surgical tools. Advances in minimally invasive surgery include robotic instruments to engage in ever more complex diagnosis and operations. Robotic instruments can provide a physician with greater movement abilities as the tool shape can be changed in the patient's body. However, with either manual surgical tool manipulation or robotic tool manipulation, the surgeon loses the ability to accurately perceive the force exerted by the tool.

### SUMMARY

Systems and methods for force sensing in a robot are provided. The force sensing can be implemented by measuring joint-level information, such as the actuation force and the displacement of a joint of the robot, and using this information to calculate the force at the distal end of the robot. For example, the force at the end of the robot can be calculated even though there is no sensor directly measuring the force at this location. The calculated force feedback provides information that may be used in the operation of the robot or to diagnose conditions. By calculating the force at the distal end of the robot, the robot can be made smaller, cheaper, and designed without the constraints of placing a sensor at the distal end of the robot to make the force measurements.

The robot can include one or more segments that can be actuated independently of one another to provide a number of degrees of freedom. The distal end of the robot can include a tool, such as a gripper or scalpel that is used in minimally invasive operations or diagnostic procedures. The joint-level information can also be used to calculate a moment for the distal end of the robot. The force and moment information can be used for such tasks as detecting the stiffness of a surface, such as a tissue, and can be used to diagnosis disease in the tissue such as a tumor. A robot implemented with force sensing can also be designed to be magnetic resonance imaging (MRI) compatible. Information obtained from other sensors monitoring the robot can also be merged with the joint-level information to improve the calculation of the force and moment at the distal end of the robot. This sensor-based information can include information from a vision system, tracking information regarding the robot's movements, or the deflection in a joint of a robot. Additionally, the force sensing abilities of a robot can be calculated to determine how well a robot design will be able to implement force sensing.

### BRIEF DESCRIPTION OF THE DRAWINGS

FIG. 1 illustrates a continuum robot in accordance with some embodiments;

FIG. 2 illustrates a continuum robot with independently controlled sections in accordance with certain embodiments;

FIG. 3 illustrates a cross section of a base section end disk in accordance with certain embodiments;

FIG. 4 illustrates a continuum robot with a tool attachment in accordance with certain embodiments;

FIG. 5 illustrates a continuum robot with an actuation unit in accordance with certain embodiments;

FIG. 6 illustrates kinematics nomenclature for a bent robot in accordance with certain embodiments;

FIG. 7 illustrates kinematics nomenclature for a straight robot in accordance with certain embodiments;

FIG. 8 illustrates a chart for providing force sensing in a robot in accordance with certain embodiments;

FIGS. 9A, 9B, and 9C illustrate force sensing in palpation, incision, and suture penetration respectively in accordance with certain embodiments;

FIGS. 10A and 10B illustrate case studies of a single segment robot in accordance with certain embodiments;

FIGS. 11A, 11B, and 11C illustrate tests of a single segment robot in accordance with certain embodiments;

FIG. 12 illustrates stiffness measurements recorded by a single segment robot in accordance with certain embodiments;

FIG. 13 illustrates a three segment robot with corresponding coordinate references in accordance with certain embodiments;

FIG. 14 illustrates a chart for providing force sensing in a robot in accordance with certain embodiments;

FIGS. 15A and 15B illustrate palpitation of a simulated prostate by a three segment robot;

FIG. 16 illustrates a Stanford manipulator robot palpating a prostate from the top in accordance with certain embodiments.

### DETAILED DESCRIPTION

Apparatus and methods for providing force feedback for robotic instruments are provided. In order to perform minimally-invasive surgery, doctors need to be able to view the effected area and operate on it using surgical tools or robotic instruments inserted into the patient's body. However, as such tools and robots place the doctor further from the area being operated on, or on which diagnosis is being performed, there can be a loss of dexterity and information upon which decisions can be made. For example, manual, minimally-invasive surgical procedures carried out using long, rigid instruments can make certain tasks, such as creating an incision or tying a stitch, more complicated than if simply done with the doctor's own hands. This is because in using such instruments, a doctor can be constrained in the range of movements needed to perform the tasks, and the feedback received through the tools is different than using the doctor's own hands directly on the effected area.

The development of robotic instruments can establish new surgical paradigms that allow diagnosis and operation through either a natural body orifice or a small incision. These techniques often require the surgeon to traverse channels with the instruments in order to reach the surgical site without applying undue forces to the surrounding bodily structures, so there is a need for compact, insertable surgical devices and instruments capable of providing force feedback to the operating physician. Force feedback is an important factor for improved patient safety, precise manipulation, grasping or palpation of soft organs, and for improved transparency in master/slave tele-operation for precise suture placement. Further, force feedback can be used in diagnosis of conditions because it can allow the doctor to detect structures within the body of differing size, shape, and stiffness with respect to surrounding bodily structures. This information can then be used to detect of diseased tissue in a patient, such as a tumor, fibrosis of a liver, fatty tissue, or any other anomaly. Intrinsic force sensing can be provided in robotic surgical tools to provide such force feedback to the doctor. For example, force information can be obtained from sensors within the structure of the robotic tool and processed by a processing unit, such as a microprocessor or integrated circuit. In addition, surgical robots and tools can be designed to be compatible with diagnostic machinery, such as a magnetic resonance imaging (MRI) machine, to allow for use of such diagnostic devices during surgery while the robots and tools are positioned in the patient's body. For example, the robots and tools can be formed of particular materials that do not interfere with the diagnostic machinery.

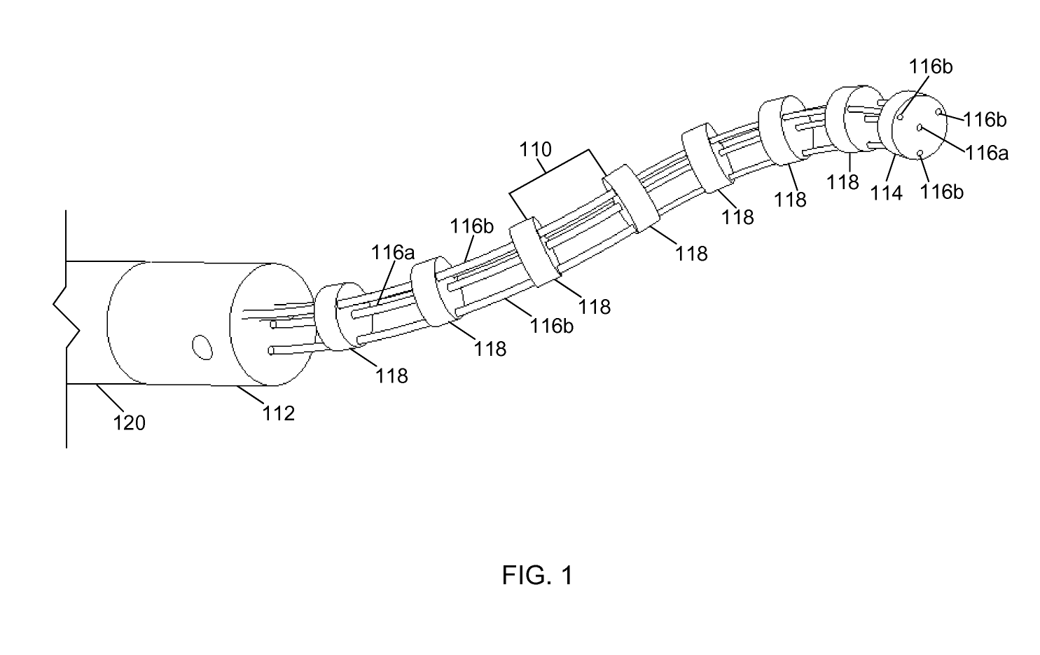

One type of robot that in which intrinsic force sensing can be implemented is a continuum or “snake-arm” robot. A continuum robot can be highly flexible, which allows the robot to curve and move with a number of degrees of freedom. A FIG. 1 illustrates a continuum robot in accordance with certain embodiments. The continuum robot includes a number of segments 110, which can be similar in construction to one another. A base disk 112 is provided at a proximal end of the robot, which can be connected to an actuation unit or support structure, as further discussed below. The base disk 112 can interconnect with a lumen 120, which can be a simple hollow tube in some embodiments. The lumen 120 allows the robot to be introduced into a patient's body. An end disk 114 at the distal end of the robot provides for attachment of various tools, which can be designed to provide certain features, such as drug delivery. The base disk 112 and end disk 114 are coupled by a number of backbones 116, which can be pushed and/or pulled by actuation unit (not shown) to cause the robot to bend in a desired manner. The number of backbones 116 can vary, as can the arrangement of the backbones. In FIG. 1, for example, four backbones 116 are shown. Between the base disk 112 and end disk 114, a number of spacer disks 118 can be arranged. The disks and backbones are arranged in a number of segments 110 to form a continuous and flexible robot.

The disks can be manufactured from a biocompatible material that can be designed to withstand the loads placed upon them in use. In some embodiments, the base disk 112 and end disk 114 are manufactured differently than the spacer disks 118 to provide for interconnection with other equipment or tools. The spacer disks 118 can be made, for example, from Polytetrafluoroethylene (PTFE), which is compatible with diagnostic machinery such as magnetic resonance imaging (MRI). The base disk 112 and end disk 114 can be composed of polymer-based or ceramic materials that are MRI compatible. In devices that are not meant for extensive MRI use, aluminum can be used for the base disk 112 and end disk 114. The backbones 116 can be made from a biocompatible flexible tubular material, which can be super-elastic, such as nickel titanium (NiTi). The backbones 116 are selected from materials and designed with respect to diameter and tube wall thickness to provide bending flexibility, while providing stiffness in the axial direction. The stiffness in the axial direction allows for pulling and pushing of the backbones 116 which provides movement of the robot and prevents deformation of the backbones.

One primary backbone 116a can be centrally located among the disks and can be attached to the base disk 112 and the end disk 114. The primary backbone 116a also can be attached to the spacer disks 118 in some embodiments. Secondary backbones 116b can be arranged around the primary backbone 116a towards the edge of the disks. The secondary backbones 116b can be placed equidistant from the primary backbone 116a. The secondary backbones 116b are attached to the end disk 114 and slide in holes having appropriate tolerances in the base disk 112 and spacer disks 118. The secondary backbones 116b are used to manipulate and control the movement of the robot. The movement can be directed by either pushing or pulling on each secondary backbone 116b to move the robot in the desired direction. In FIG. 1, three secondary backbones 116b are used with one primary backbone 116a. Various other configurations are also possible, such as having four secondary backbones with one primary backbone. By increasing the number of secondary backbones in some embodiments, the additional secondary backbones allow more freedom in determining the load distributed among the backbones. This load distribution can be achieved through a process of actuation redundancy resolution.

The backbones can also serve multiple purposes in some embodiments. For example, backbones can serve as a suction channel, a fluid delivery channel, an actuation channel for a tool mounted on distal end of the robot, a light source, and/or an imaging source. As a suction channel, the backbone can be used to remove fluid, residue, or to hold an object via suction. The backbone, as a fluid delivery channel, can administer drugs or other markers to the site where the robot is located. When a tool is mounted on the robot, a backbone can be used to effect movement or the backbone can include a mechanism for effecting movement such as a wire positioned within a hollow backbone. A fiber optic cable can be used within a backbone to provide light for imaging purposes at the distal end of the robot. Also, the backbone can provide a channel for sensor or imaging information to be fed back to a controller or processor which is used to process this information. These vision capabilities can be provided by a fiber optic array attached to a CCD camera in some embodiments. The backbone or a separate channel can be used to implement laser delivery or cautery, which can be used for surgical or diagnostic purposes.

The spacer disks 118 are arranged along the backbones to support the backbones and to maintain a particular distance between the backbones 116 throughout the segments 110. The spacer disks 118 are spaced sufficiently apart from one another so as not to limit the range of the bending motion (unless this is desired). In order to minimize friction on the backbones 116, a low friction material, e.g., PTFE, can be used for bushings around the holes of disks or the disks themselves can be made from a low friction material. The base disk 112 can be configured to attach to a lumen 120, which can provide maneuverability of the robot from the entry incision to the site where the robot is needed. The lumen 120 also provides a channel for the backbones to be connected to the actuation unit. The elastic structure of the lumen 120 can be a tube formed of polymer elastomers, a super-elastic tube that is micro-machined to provide flexure hinges, or any other serial linkage design. The lumen 120 can constructed to be rigid, passively flexible, or actively flexible. A passively flexible lumen structure bends to accommodate the anatomy. An actively flexible lumen can be implemented by allowing the shape to be locked in place or unlocked based on control information, such as a control signal sent from a controller or processor.

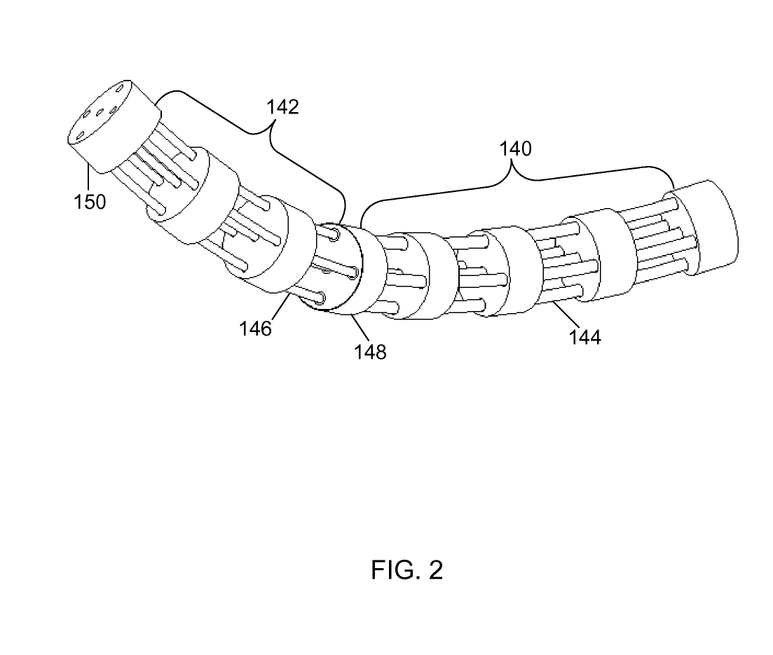

FIG. 2 illustrates a continuum robot with independently controlled segments in accordance with certain embodiments. The use of independently controlled segments provides for increased mobility of the continuum robot. The independently controlled segments can be formed by using additional sets of backbones. For example, one segment of the continuum robot is controlled by a first set of backbones and a second segment is controlled by a second set of backbones. A base section 140 provides mobility to the proximal portion of the continuum robot and a distal section 142 provides independent mobility to the distal portion of the continuum robot. Additional intermediate segments can be added, although not shown, which provide separate mobility from the base segment 140 and distal segment 142. The base segment 140 provides attachment to a lumen or actuation unit, and the backbones 146 of the distal segment 142 can be positioned within the hollow backbones 144 of the base segment. In such embodiments where the second set of backbones are run internally within the first set of backbones the backbones may be coated with a low friction material to prevent wearing among the components and to avoid bunching of the backbones. Depending on the material selected for the backbones, this may not be needed in some embodiments. The end disk 148 of the base segment 140 provides an attachment point for the secondary backbones. The attachment of the secondary backbones to the end disk 148 allows these backbones to be actuated independently of the backbones of the distal section 142. The distal section backbones 146 remain unattached until the end disk 150 of the distal section 142. This configuration allows the base backbones 144 to be actuated in a first direction, while the distal backbones are actuated in a second and opposite direction unaffected by the position of the base section 140 of the continuum robot.

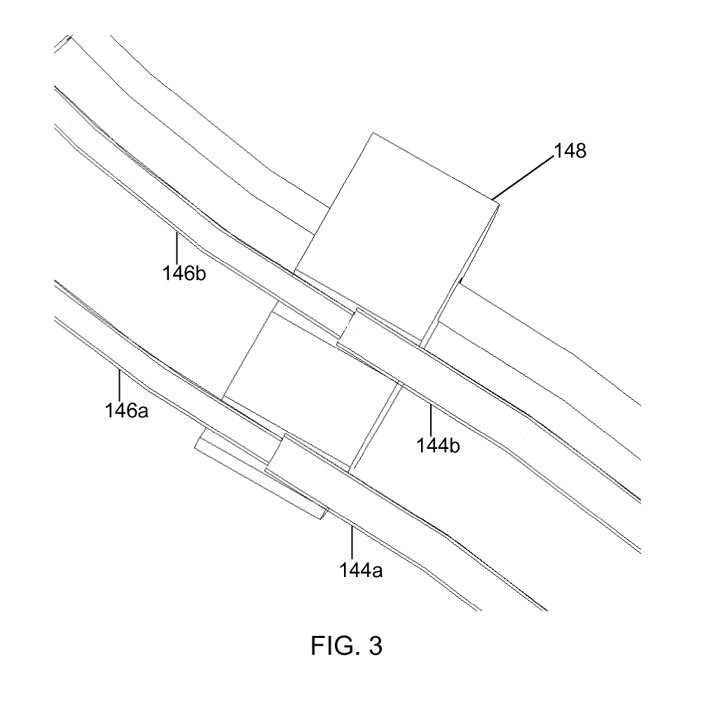

FIG. 3 illustrates a cross section of a base segment end disk 148 in accordance with some embodiments. As shown, the distal segment secondary backbones 146 (a and b) are positioned within the base segment secondary backbones 144 (a and b). The base segment secondary backbones 144 (a and b) are attached to the base segment end disk 148 allowing movement of the base segment of the continuum robot through pushing and pulling actuations of the secondary base segment backbones 144 (a and b). On the other hand, the distal segment secondary backbones 146 (a and b) are unattached at end disk 148, so they can operated independently of the base segment secondary backbones 144 (a and b), which allows for independent movement of the base and distal segment.

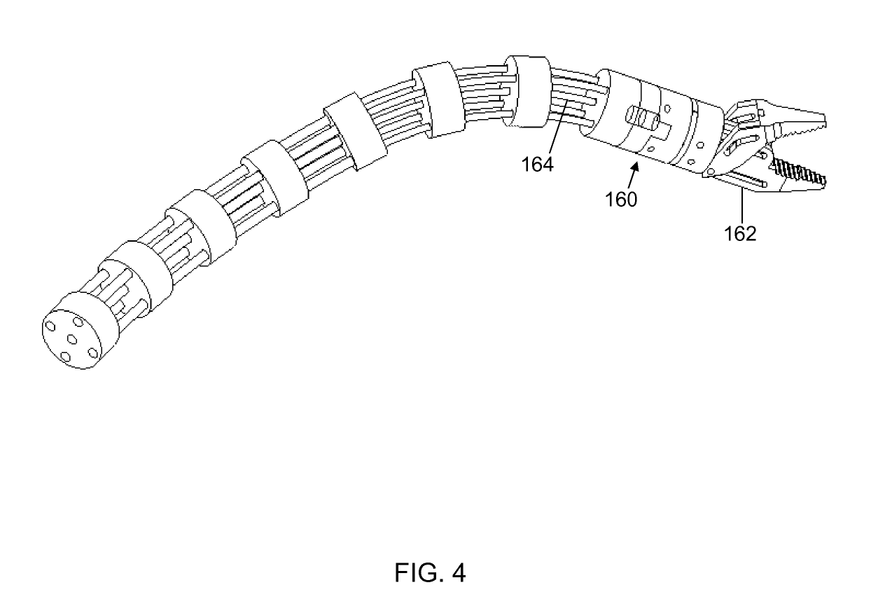

FIG. 4 illustrates a continuum robot with a tool attachment in accordance with some embodiments. The design of the continuum robot in FIG. 4 uses one primary backbone surrounded by four secondary backbones. The use of an even number of secondary backbones provides for simplified actuation and control of the continuum robot. For example, when an even number of secondary backbones are used, an opposing pair of secondary backbones can be pushed and pulled by a particular differential amount to effect movement of the continuum robot in the plane of the opposing backbones, which lends itself to less complex mechanical actuators or controller of the mechanical actuators. For example, a reciprocal mechanism, such as a cable and pulley arrangement, could be used to apply a differential force to the pair of opposing backbones. The secondary backbones can be used to provide actuation to a tool attachment, for example, by using actuation wires that pass through the backbones to connect to the tool. In the example of FIG. 4, a wrist 160 with a gripper 162 is used as a tool attachment. The tool attachment can be used to support knot tying and passing sutures in very confined spaces and can minimize the motion of the continuum robot during procedures. Other tool attachments may also be used such as a surgical knife, a probe, a drug delivery attachment, or any other design. The tool attachment can be actuated by a primary backbone or by a wire running inside a backbone, for example. Also information collected by a probe or other sensor provided in a probe can be carried in a wire or fiber optic cable back to a processor or computer readable medium.

The tool attachment can be connected to the continuum robot in a number of ways. For example, the central backbone, alone or in combination with the secondary backbones, can be used to attach the tool. The attachment backbone can, for example, have a ball at the end which fits into a locking mechanism of the tool attachment. In some embodiments, if no tool attachment is used, the backbone balls can be locked into the end disk of the continuum robot. Other shapes also can be used on the end of the backbone to provide a locking connection. The tool attachment can also be secured by the use of a threaded attachment, a spring lock, a groove and ridge locking system, or any other connecting mechanism. In some embodiments, the central backbone can be used for delivering actuation for the tool attachment by using a super-elastic wire in pushing mode. The two remaining backbones may be used for delivering other sources of sensory data or for capabilities such as vision or drug delivery.

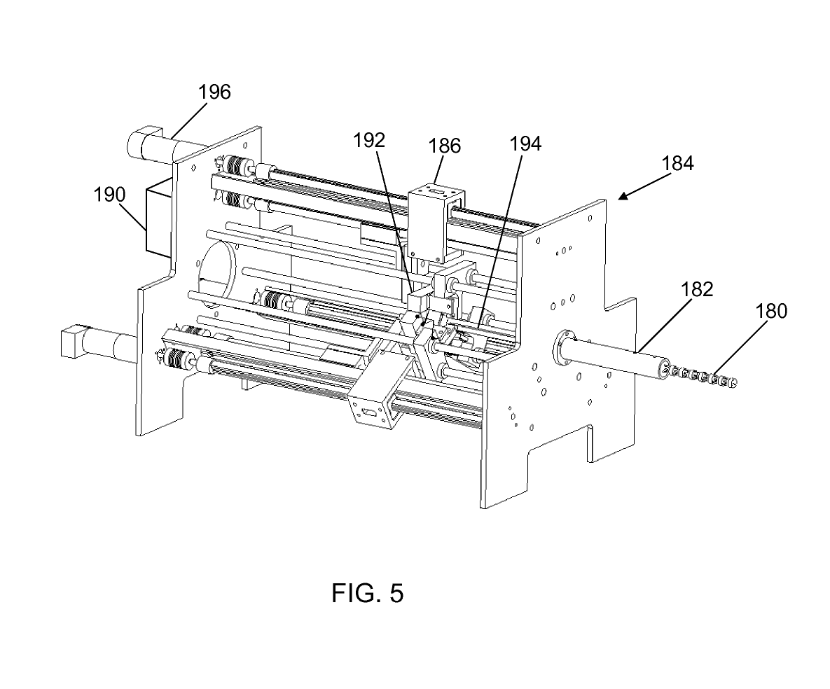

FIG. 5 illustrates a continuum robot with an actuation unit in accordance with some embodiments. The robot 180 can be attached to a lumen 182 which in turn connects to an actuation unit 184. The actuation unit 184 includes a mechanism for independently pushing or pulling each of the attached backbones by a desired amount. For example, the actuator can have a number of actuation sliders 186 that move back and forth on guide rails 188. Each actuation slider 186 can be used to push and pull a particular backbone. The actuation unit 184 can include a controller or a processing unit 190 that aids in controlling the movement of the robot and any tools attached to the robot. The force applied by each actuation slider 186 to each backbone can be monitored by sensors 192. Specifically, the sensors 192 can be used to measure the force, i.e., tension or compression, in each backbone. In some embodiments, the sensor 192 is placed between an actuation rod 194 that attaches to the backbone and actuation slider 186. The actuation rod 194 can be a metal rod and is used to provide a linkage between the actuation slider and the backbone in certain embodiments. Additionally, the displacement of each backbone can also be measured. The displacement is the distance each backbone is moved. For example, if the actuation slider 186 pushes the backbone one centimeter, then the displacement is one centimeter. The displacement can be measured, for example, by the controller/processing unit 190, which records the amount the actuation slider 186 is moved. This can entail the controller/processing unit 190 tracking movement instructions sent to an actuation device 196 and calculating the distance the actuation slider 186 is moved.

The actuation device 196 can be implemented with a motor, a pneumatic pump, a hydraulic pump, a piezoelectric actuator, or any other applicable device. If a motor is used, an ultrasonic motor can be used to provide MRI compatibility. The motor can be used to change the displacement of actuation rod 194, which in turn is attached to a backbone, by turning a screw or using a rack and pinion. FIG. 5 illustrates a motor as actuation device 196 with a screw based actuation of the actuation slider 186 to move the actuation rod 194. The screw-based actuation uses a threaded rod to move the actuation slider 186 along the treaded rod by rotating the rod. In some embodiments, the actuation unit 184 can be implemented and manufactured differently than was described above. For example, the actuation unit can be manufactured smaller to make the device handheld for medical procedures.

As further discussed below, the forces measured on the backbones can be used to determine the force experienced by the distal end of the robot. The sensors 192 can be pizo-electric devices, such as load cells, or strain gauges in some embodiments. Other sensors, such as a fiber Bragg Grating optical sensor, can be used within the core of a fiber optic cable within one or more backbones to determine the strain distributed along the fiber cable. Capacitive sensors imbedded between the disks of the continuum robot provide yet another way of sensing the force along the continuum robot. The sensors can also be designed to provide MRI compatibility, such as by using fiber optic sensing or locating the sensors at the base outside the MRI machine.

The information collected from the sensors is sent to a processor 190 to calculate the force and moment at the distal end of the continuum robot. The controller/processor 190 can communicate with the sensors, the actuation device 196, and any other devices using communication lines, e.g., copper based lines, such as Ethernet. The controller/processor 190 can deliver instructions and control the operation of the robot controlling the actuation devices 194. The instructions can be received by a graphical user interface (GUI), a command line interface, a joystick, a mouse, or any other input device. The force and moment information computed by the processor can be used to provide feedback to the surgeon during diagnostic or surgical procedures. For example, the force sensing can aid in determining the shape and stiffness of objects within the patient's body, and can help find hidden features in such objects, which can be useful in tumor detection and other applications. The force feedback information can be used to provide tactile feedback, for example by providing resistance in the user controls, as well as visual feedback. The feedback information can also be recorded to a computer readable medium for later analysis. The force feedback can thus be used to aid in surgical operations as well as in diagnostic settings.

In some embodiments, information from probes at the distal end of the continuum robot can be sent to the user along with the force feedback. For example, an ultrasound probe can be used, and the information from the probe can be merged with the information from the force sensing. Merging these two sources of information provides surface hardness information from the force sensing along with imaging information from inside the tissue from the ultrasound. The force sensing information can also be merged with other measurement information, in certain embodiments, to determine the force and moment of the distal end of the robot. For example, vision information can provide a measurement of slippage of the robot, which can be used in calculating the force and moment of the robot.

The force information from sensors 192 is used to provide force sensing in the robot. The force sensing can be used to provide a force and moment measurement at the distal end of the robot using an algorithm and sensor measurements. The algorithm is based on the singular value decomposition of the Jacobian mapping between the configuration space and the twist space of the end effector. The end effector can be the end disk of the robot or a tool attachment. The force sensing provided by the remote sensor measurement allows for force sensing in challenging environments where placing sensors at the distal end of a robot is not possible due to the limitations such as size of the robot and/or MRI compatibility.

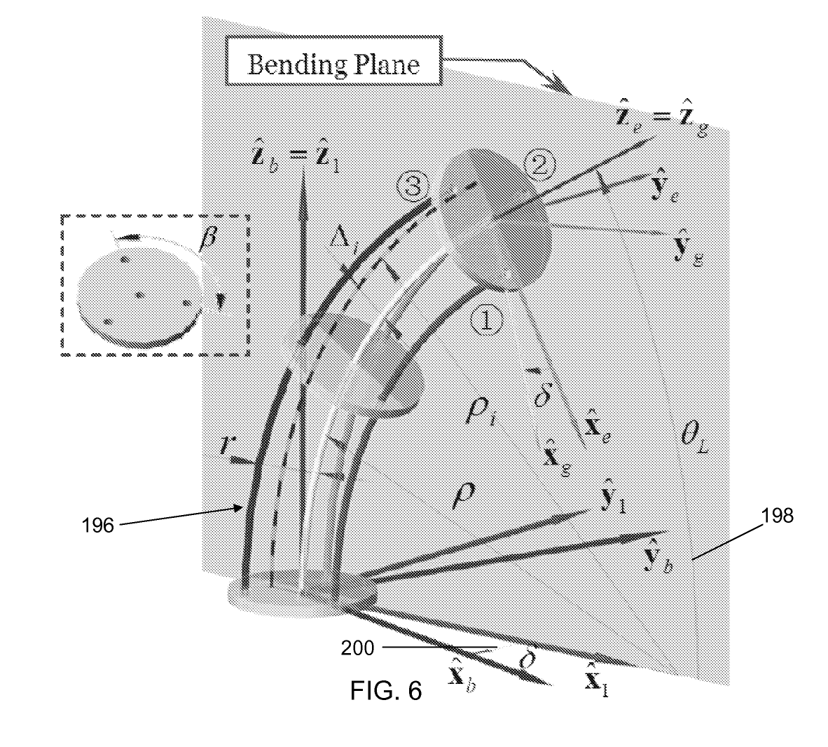

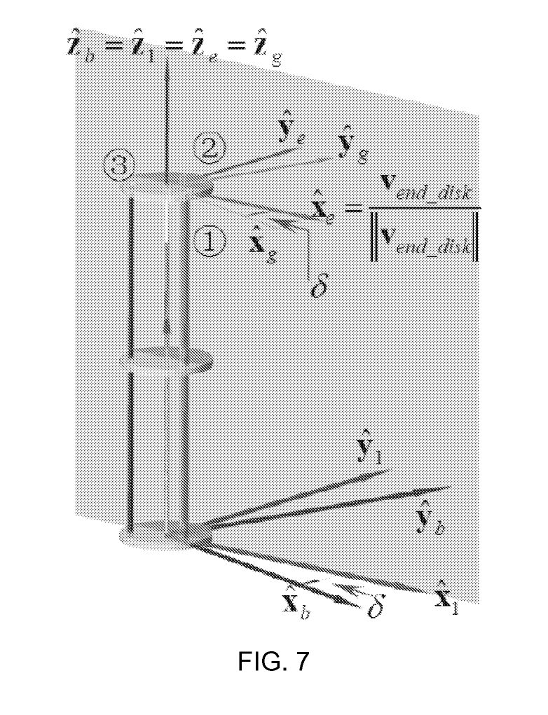

The algorithm to provide force sensing on a robot can be derived in the following fashion with the following nomenclature. Force sensing is first described for a single segment, and later the equations are expanding to accommodate a robot with any number of segments. As shown in FIGS. 6 and 7, the Base Disk Coordinate System (BDS) {\hat{x}_{b},ŷ_{b},\hat{z}_{b}} is associated with the base disk, whose XY plane is defined to coincide with the upper surface of the base disk, and its origin is at the center of the base disk. The \hat{x}_{b} points from the center of the base disk to the first secondary backbone while the \hat{z}_{b} is perpendicular to the base disk. The three secondary backbones are numbered according to the definition of δᵢ. The Bending Plane Coordinate System (BPS) {\hat{x}ₗ,ŷₗ,\hat{z}ₗ} is defined such that the continuum robot bends in the XZ plane, with its origin coinciding with the origin of BDS. The End Disk Coordinate System (EDS) {\hat{x}ₑ,ŷₑ,\hat{z}ₑ} is obtained from BPS by a rotation about ŷₗ such that \hat{z}ₗ becomes the backbone tangent at the end disk. The origin of EDS is at the center of the end disk. The Gripper Coordinate System (GCS) {\hat{x}_{g},ŷ_{g},\hat{z}_{g}} is associated with a tool, such as a gripper affixed to the end disk. \hat{x}_{g} points from the center of the end disk to the first secondary backbone and \hat{z}_{g} is normal to the end disk. GCS is obtained by a right-handed rotation about \hat{z}ₑ. Table 1 provided below lists nomenclature used in describing the force sensing algorithm for a single segment robot. FIG. 6 illustrates the kinematics nomenclature (further described in Table 1) for a bent robot 196 in accordance with certain embodiments. As shown in FIG. 6, θ_{L} 198 is an angle that measures the bending of the robot and δ can represent the plane in which the bending is occurring. FIG. 7 illustrates kinematics nomenclature (further described in Table 1) for a straight robot in accordance with certain embodiments.

TABLE 1
Nomenclature for a Single Segment Robot

| | |
|---|---|
| i | Index of the secondary backbones, i = 1, 2, 3 |
| s | Arc-length parameter of the primary backbone |
| L, Lᵢ | Length of the primary and the i^{th} secondary backbone measured from the base |
| | disk to the end disk |
| qᵢ | Joint parameter of the i^{th} secondary backbone qᵢ = Lᵢ − L |
| r | Radius of the pitch circle defining the positions of the secondary backbones in all |
| | the disks. |
| β | Division angle of the secondary backbones along the circumference of the pitch |
| | circle, β = 2π/3 |
| ρ(s) | Radius of curvature of the primary backbone |
| ρᵢ(s) | Radius of curvature of the i^{th} secondary backbone |
| θ(s) | The angle of the tangent to the primary backbone in the bending plane. θ\|_{s=L} and |
| | θ\|ₛ₌₀ are designated by θ_{L} and θ₀, respectively. NOTE: θ₀ = π/2 is a constant. |
| δᵢ | A right-handed rotation angle from \hat{x}₁ about \hat{z}₁ to a line passing through the |
| | primary backbone and the i^{th} secondary backbone at s = 0. At a straight |
| | configuration \hat{x}₁ is along the same direction as the desired instantaneous linear |
| | velocity of the end disk. |
| δ | δ ≡ δ₁ and δᵢ = δ + (i − 1)β, i = 1, 2, 3 |
| Δᵢ | Radial offset from primary backbone to the projection of the i^{th} secondary |
| | backbone on the bending plane. |
| J_{yx} | Jacobian matrix of the mapping \dot{y} = J_{yx}\dot{x} where the dot over the variable |
| | represents time derivative. |
| Eₚ, Eₛ | Young's modulus of the primary and the secondary backbones. |
| Iₚ, Iₛ | Cross-sectional moments of inertia of the primary and the secondary backbones |
| τ | Actuation forces of the secondary backbones τ ∈ [symbol] ^{3×1}. |
| ¹R₂ | Rotation matrix of frame 2 with respect to frame 1. |
| ^{b}p | Position vector of the robot tip in the BDS |
| \dot{x} | The twist \dot{x} ∈ [symbol] ^{6×1} of the end disk in a frame instantaneously parallel to BDS and |
| | centered at center of the end disk. \dot{x} is defined with the linear velocity vector |
| | preceding the angular velocity vector. |

The position and orientation of the end disk relative to the base disk is characterized by two angles θ_{L} and δ. Equations 1 and 2 provide a relation between the two angles θ_{L} and δ.

Lᵢ=L+qᵢ=L+Δᵢ(θ_{L}−θ₀) (1)

Δᵢ≡r cos(δᵢ), i=1, 2, 3 (2)

For a given qᵢ, the robot configuration ψ=[θ_{L} δ]^{T} is given by equations 3 and 4.

θ_{L}=θ₀+qᵢ/Δᵢ (3)

δ=atan 2(q₂−q₁ cos β,−q₁ sin β) (4)

The instantaneous direct kinematics is then given by equation 5.

\dot{x}=J_{xψ}\dot{ψ} (5)

Since the robot includes flexible members (e.g., the backbones), the shape of the robot is determined by the minimal energy solution with a corresponding Jacobian matrix in equation 6. Equation 6 is ill-defined when θ_{L}=θ₀=π/2. This singularity for the configurations θ_{L}=θ₀=π/2 is resolved by applying the L'Hopital rule to get equation 7. For these configurations, the robot bending plane is defined according to the desired linear velocity of the end disk as is shown in FIG. 7.

$$\begin{matrix}{J}_{x ψ} = [ \begin{matrix}{Lc}_{δ} \frac{( {θ}_{L} - {θ}_{0} ) {c}_{{θ}_{L}} - {s}_{{θ}_{L}} + 1}{{( {θ}_{L} - {θ}_{0} )}^{2}} & - L \frac{{s}_{δ} ( {s}_{{θ}_{L}} - 1 )}{{θ}_{L} - {θ}_{0}} \\ - {Ls}_{δ} \frac{( {θ}_{L} - {θ}_{0} ) {c}_{{θ}_{L}} - {s}_{{θ}_{L}} + 1}{{( {θ}_{L} - {θ}_{0} )}^{2}} & - L \frac{{c}_{δ} ( {s}_{{θ}_{L}} - 1 )}{{θ}_{L} - {θ}_{0}} \\ L \frac{( {θ}_{L} - {θ}_{0} ) {s}_{{θ}_{L}} + {c}_{{θ}_{L}}}{{( {θ}_{L} - {θ}_{0} )}^{2}} & 0 \\ - {s}_{δ} & {c}_{δ} {c}_{{θ}_{L}} \\ - {c}_{δ} & - {s}_{δ} {c}_{{θ}_{L}} \\ 0 & - 1 + {s}_{{θ}_{L}}\end{matrix} ] & ( 6 ) \\ {lim}_{{θ}_{L} \to {θ}_{0} = \frac{π}{2}} {J}_{x ψ} = [ \begin{matrix}- \frac{L}{2} {c}_{δ} & 0 \\ \frac{L}{2} {s}_{δ} & 0 \\ 0 & 0 \\ - {s}_{δ} & 0 \\ - {c}_{δ} & 0 \\ 0 & 0\end{matrix} ] & ( 7 )\end{matrix}$$

The instantaneous inverse kinematics is given in equation 8.

\dot{q}=J_{qψ}\dot{ψ} (8)

By taking the derivative of equation 1 for qᵢ, i=1, 2, 3, equation 9 is obtained.

$${J}_{q ψ} = [ \begin{matrix}r cos ( δ ) & - r ( {θ}_{L} - {θ}_{0} ) sin ( δ ) \\ r cos ( δ + β ) & - r ( {θ}_{L} - {θ}_{0} ) sin ( δ + β ) \\ r cos ( δ + 2 β ) & - r ( {θ}_{L} - {θ}_{0} ) sin ( δ + 2 β )\end{matrix} ] \qquad ( 9 )$$

The elastic energy of a continuum robot can be determined by equation 10 if twisting, extension of the backbones, friction, and gravity are neglected.

$$E = {\int }_{L} \frac{EI}{2} {( \frac{d θ}{d s} )}^{2} d s = {( {θ}_{L} - {θ}_{0} )}^{2} ( \frac{{E}_{p} {I}_{p}}{2 L} + {\sum }_{i = 1}^{3} ( \frac{{E}_{s} {I}_{s}}{2 {L}_{i}} ) ) \qquad ( 10 )$$

The force fₑ and moment mₑ that acts on the end disk can be found by finding an external wrench Wₑ[fₑ^{T} mₑ^{T}]^{T}. This external wrench perturbs the robot's position and orientation of the end disk by Δx, which caused by a corresponding change in the lengths of the secondary backbones Δq=[Δq₁ Δq₂ Δq₃]^{T}. The actuation forces on the secondary backbones which maintain the equilibrium of the robot in the perturbed state are τ=[τ₁ τ₂ τ₃]^{T}. The change in the potential energy ΔE that corresponds to the movement Δx is given by equation 11.

Wₑ^{T}Δx+τ^{T}Δq=ΔE (11)

The concept of virtual displacement is used to further develop prior equations. The virtual displacement is characterized by Δψ=[Δθ_{L} Δδ]^{T}. Using equations 5 and 8, the virtual work principle is rewritten as equation 12. To achieve a static equilibrium condition, the terms associated with each independent degree of freedom should vanish. The matrix form of this system of linear equations is given in equation 13 where ∇E represents the gradient of the elastic energy with respect to the configuration perturbation Δψ.

Wₑ^{T}J_{xψ}Δψ+τ^{T}J_{qψ}Δψ−∇E^{T}Δψ=0 (12)

J_{qψ}^{T}τ+J_{xψ}^{T}Wₑ=∇E (13)

For the actuation forces, a redundancy resolution of equation 13 is obtained in equation 14.

τ=(J_{qψ}^{T})⁺(∇E−J_{xψ}^{T}Wₑ)+(I−(J_{qψ}^{T})⁺J_{qψ}^{T})ξ (14)

In equation 14, ξε [symbol] ^{3×1} is a vector of homogeneous actuation forces used to optimize the loads on the backbones and ∇E is equal to:

$$∇ E = [ \begin{matrix}\begin{matrix}( {θ}_{L} - {θ}_{0} ) ( \frac{{E}_{p} {I}_{p}}{L} + {\sum }_{i = 1}^{3} \frac{\text{?} \text{?}}{{L}_{i}} ) - \\ \frac{{( {θ}_{L} - {θ}_{0} )}^{2}}{2} {E}_{s} {I}_{s} r {\sum }_{i = 1}^{3} \frac{cos {δ}_{i}}{{L}_{i}^{2}}\end{matrix} \\ \frac{{( {θ}_{L} - {θ}_{0} )}^{3}}{2} {E}_{s} {I}_{s} r {\sum }_{i = 1}^{3} \frac{sin {δ}_{i}}{{L}_{i}^{2}}\end{matrix} ]$$

$$\text{?} \text{indicates text missing or illegible when filed}$$

In the compensated actuation of the robot, one redundancy resolution is adopted in equation 15.

τ=J_{qψ}(J_{qψ}^{T}J_{qψ})⁻¹(∇E−J_{xψ}^{T}Wₑ) (15)

In order to develop a force sensing algorithm, equation 13 is rewritten as equation 16.

J_{xψ}^{T}Wₑ=∇E−J_{qψ}^{T}τ (16)

A force sensing capability can be provided for a robot if the actuation forces τ are measured by sensors (e.g., sensors 192 discussed above). For a single segment robot, the actuation forces τ and the displacement Lᵢ, or length of the backbone, are known for the segment. There are six unknown wrench components in Wₑ in equation 16, which can be solved using a combination of joint-level information and equations arising known conditions. The joint-level information includes measurements of the force on a backbone and the displacement of the backbone. A solution to the wrench components is provided through equation 17, where Wₛ is the sensed external wrench and N=(I−(J_{xψ}^{T})⁺(J_{xψ}^{T})) is the null-space projector of J_{xψ}^{T} and (J_{xψ}^{T})⁺=J_{xψ}(J_{xψ}^{T}J_{xψ})⁻¹. For any ηε [symbol] ^{6×1}, J_{xψ}^{T}Nη does not affect the static equilibrium of the robot. For robots of one or two segments, Wₛ is split into a component W_{sb} designating sensible wrenches, and a component W_{isb} representing wrenches solved through known conditions. These components are used to form equation 18. It is important to note that the component W_{isb} is referred to in the explanation of the algorithm as insensible wrenches, which are not measured through the backbones for one or two segment robots. The insensible wrenches are calculated by using known conditions in the force sensing algorithm. The known conditions can be obtained from a database, from user input, or from other sensory equipment that can provide additional information about the robot. The known conditions can also be used to further increase the accuracy of force sensing calculations. For example, sensor information such as vision information measuring the deflection of tissue, tracking a tool attachment (e.g., magnetic tracking, visual tracking, ultra-sound sound tracking, or marker/radio frequency based tracking), and/or measuring the deflection of the backbone through a fiber optic cable can be merged with the joint-level information to provide a more accurate force and moment calculation at the distal end of the robot.

Wₛ=(J_{xψ}^{T})⁺(∇E−J_{qψ}^{T}τ)+Nη (17)

Wₛ=W_{sb}+W_{isb} (18)

W_{sb}=(J_{xψ}^{T})⁺(∇E−J_{qψ}^{T}τ)W_{isb}=Nη

The resolution for Wₛ in equation 17 depends on the joint-level information and on the known conditions, which can be a-priori knowledge. The a-priori knowledge leads to the homogenous solution of W_{isb} while the joint-level information leads to W_{sb}. There may be several sources of known conditions or a priori knowledge available to resolve W_{isb}. One type of a-priori knowledge stems from the geometry of the contract between the robot and its environment. This is because difference types of contacts (e.g., point, line, plane contacts with or without friction) are associated with different wrenches and known conditions. Each type of contact geometry provides information about certain null components of the wrench that acts on the robot. Wₛₑε [symbol] ^{6×1} can be used to designate the a-priori wrench estimate with these null components, while Sₑε [symbol] ^{6×6} can be used to designate the associated weights. Wₛ can be determined using a constrained least squares problem as shown in equation 19 with a closed-form solution shown in equation 20.

η=argmin((Wₛ−Wₛₑ)^{T}Sₑ(Wₛ−Wₛₑ))

s.t. Wₛ=(J_{xψ}^{T})⁺(∇E−J_{qψ}^{T}τ)+(I−(J_{xψ}^{T})⁺(J_{xψ}^{T}))η (19)

η=Ω⁺(I−(J_{xψ}^{T})⁺(J_{xψ}^{T}))^{T}Sₑ(Wₛₑ−(J_{xψ}^{T})⁺(∇E−J_{qψ}^{T}τ)) (20)
Where Ω=(I−(J_{xψ}^{T})⁺(J_{xψ}^{T}))^{T}Sₑ(I−(J_{xψ}^{T})⁺(J_{xψ}^{T}))

Force sensing can be applied to a one or two segment robot using an algorithm that calculates the sensible wrench space and the insensible wrench space based on measured actuation forces. For example, for any external wrench Wₑ, its projection in the sensible wrench space {W_{sb}} can be calculated from equation 17 as η=0, and its projection in the insensible wrench space {W_{isb}} can be calculated from equation 19 making use of the known conditions or a priori knowledge.

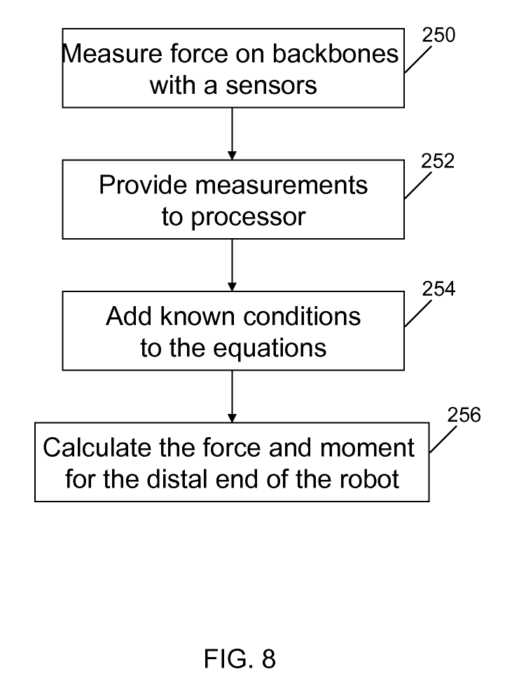

FIG. 8 illustrates a chart for providing force sensing in a one or two segment robot in accordance with some embodiments. In reference 250, sensors measure the force on the backbones. The measurements may be in analog or digital form. If an analog signal is provided by the sensor, an analog-to-digital converter can be used to convert the analog signal to a digital signal. In reference 252, the measurements are provided to a processor that is in operable communication with the sensors. Displacement information about the backbones can also be provided to the processor. In reference 254, known conditions or a priori information is provided to the processor. This information may be vision information, tracking information about the robot, ultra-sound information, or intrinsic information that is stored in a computer readable memory. The intrinsic information may include information that is used in certain procedures, regarding certain objects (e.g., young's modulus of tissue), or in certain environments. The known conditions can also be merged with the measurements of the force on the backbones to calculate the force at the distal end of the robot. In reference 256, the processor uses the measurements received to perform a calculation of the force and moment at the distal end of the robot. The distal end can be a tool in use by the robot or the end disk of the robot. The force and moment can provide information for use in a palpation, an incision, or a suture penetration, for example.

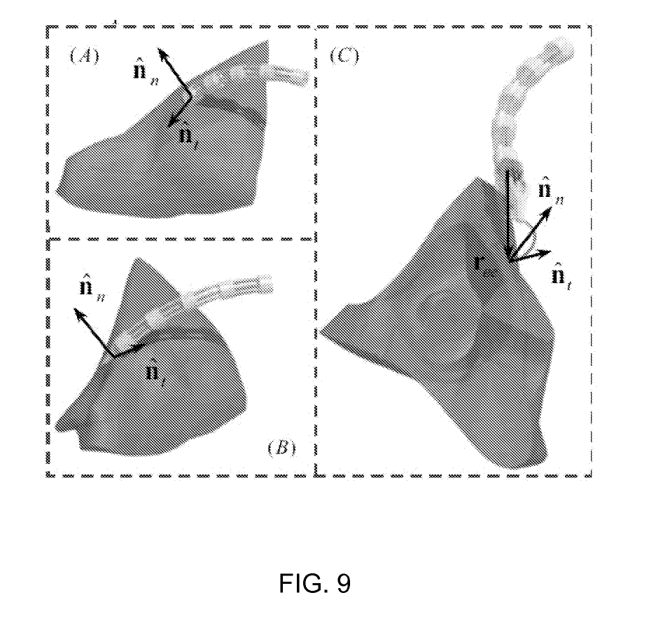

In the case of a palpation, as illustrated in FIG. 9A in accordance with certain embodiments, this information can be used to determine its size, shape, firmness, or location. For purposes of explanation, a point contact with friction is analyzed. In this case, the moment components of the external wrench Wₑ are all zero. The reaction force lies in a plane that is determined by the tissue surface normal \hat{n}ₙ and the local surface tangent \hat{n}ₜ that is opposite to the direction of the slippage between the robot and the tissue. \hat{n}ₙ and \hat{n}ₜ can be obtained by integrated vision in the robot delivered using fiber optics, for example. Wₛₑ and Sₑ then can be formulated as in equation 21, where cₜ and cₙ are any arbitrary real numbers. After using the equation 21 measurement matrixes in equation 19, the force sensing measurements can be obtained by calculating equation 22. In equation 22, fₛ and mₛ are force and moment components of the sensed wrench Wₛ.

$$\begin{matrix} {S}_{e} = [ \begin{matrix}( {\hat{n}}_{f} \times {\hat{n}}_{n} ) {( {\hat{n}}_{f} \times {\hat{n}}_{h} )}^{T} & {0}_{1 \times 3} \\ {0}_{3 \times 3} & {I}_{3 \times 3}\end{matrix} ] and {W}_{se} = [ \begin{matrix}{c}_{i} {\hat{n}}_{i} + {c}_{n} {\hat{n}}_{n} \\ {0}_{3 \times 1}\end{matrix} ] & ( 21 ) \\ η = argmin ( {f}_{s}^{γ} ( {\hat{n}}_{i} \times {\hat{n}}_{n} ) {( {\hat{n}}_{i} \times {\hat{n}}_{n} )}^{γ} {f}_{s} + \text{?} \text{?} ) \\ s . t . {W}_{s} = {( \text{?} )}^{+} ( ∇ E - \text{?} τ ) + ( 1 - {( \text{?} )}^{+} ( \text{?} ) ) η \\ \text{?} \text{indicates text missing or illegible when filed} & ( 22 )\end{matrix}$$

The minimization leads to the moment components being zero and the force residing in the plane defined by \hat{n}ₙ and \hat{n}ₜ.

In the case of an incision or a suture penetration, as illustrated in FIGS. 9B and 9C respectively in accordance with some embodiments, a line contact or a plane contact geometry can be used for purposes of calculating the force and moment. Additional interaction wrench information can be added into the formulation of Sₑ and Wₛₑ to provide force and moment sensing. The calculation depends on the geometry of the end effector, the information from other wrench sensors, or the model of the tissue and a measurement of the tissue deflection from vision information.

A singular value decomposition (SVD) of J_{xψ} from equation 23 is used to determine W_{sb} and W_{isb}. In equation 23, the matrix Dₓ=[diag(d₁,d₂) 0_{2×4}]^{T} is the matrix of singular values, Uₓε [symbol] ^{6×6} and Vₓε [symbol] ^{2×2} are unitary orthogonal matrices designating the left (output) singular vectors and right (input) singular vectors of J_{xψ}ε [symbol] ^{6×2}, correspondingly. The pseudo-inverse of J_{xψ} is expressed using the SVD as in equation 24. After substituting equation 15 into equation 18 and simplifying terms, equation 25 can be obtained. The disappearance of J_{qψ} and ∇E in equation 25 is due to using the specific actuation redundancy resolution of equation 15. After substituting the SVD of J_{xψ} into equation 25, equation 26 is obtained to express W_{sb} and W_{isb} in terms of the left singular vectors of J_{xψ}. By using the property of orthogonal matrix, I=UₓUₓ^{T}, equation 26 can be simplified to equations 27 and 28 where uₓⁱ designates the i^{th} column of Uₓ. In equation 27, it is noted that N is the null space projector of J_{xψ}^{T}, N=(I−(J_{xψ}^{T})⁺(J_{xψ}^{T}))=UₓÎUₓ^{T}.

$$\begin{matrix}\text{?} = \text{?} \text{?} \text{?} & ( 23 ) \\ {( \text{?} )}^{+} = \text{?} \text{?} \text{?} \\ Where {\tilde{D}}_{x} = {[ \begin{matrix}diag ( 1 / {d}_{1} , 1 / {d}_{2} ) & {0}_{2 \times 4}\end{matrix} ]}^{T} & ( 24 ) \\ {W}_{sb} = {( \text{?} )}^{+} \text{?} \text{?} , \text{?} = N η & ( 25 ) \\ {W}_{sb} = \text{?} \tilde{I} \text{?} {W}_{e} , W \text{?} = ( I - \text{?} \tilde{I} \text{?} ) η \\ Where \tilde{I} ≡ diag ( 1 , 1 , 0 , 0 , 0 , 0 ) and \\ \hat{I} ≡ I - \tilde{I} = diag ( 0 , 0 , 1 , 1 , 1 , 1 ) & ( 26 ) \\ {W}_{sb} = \text{?} \tilde{I} \text{?} {W}_{e} , \text{?} = \text{?} \hat{I} \text{?} η & ( 27 ) \\ {W}_{sb} = \text{?} \text{?} {W}_{e} , \text{?} = \text{?} \text{?} η \\ Where \text{?} ≡ \tilde{I} \text{?} = [ \begin{matrix}{( \text{?} )}^{T} \\ {( \text{?} )}^{T} \\ 0 \\ 0 \\ 0 \\ 0\end{matrix} ] and & ( 28 ) \\ \text{?} ≡ \hat{I} \text{?} = [ \begin{matrix}0 \\ 0 \\ {( \text{?} )}^{T} \\ {( \text{?} )}^{T} \\ {( \text{?} )}^{T} \\ {( \text{?} )}^{T}\end{matrix} ] \\ \text{?} \text{indicates text missing or illegible when filed} & \end{matrix}$$

In equation 28, the first term, UₓŨₓWₑ, depends on the geometry of the robot (through Uₓ) and on the applied wrench Wₑ. The second term UₓŨₓη does not affect the joint level sensor information τ, so the focus is on determining the first term UₓŨₓWₑ. Since uₓⁱ (i=1, . . . , 6) are the left singular vectors of J_{xψ}, they represent twists in the axial Plücker coordinates consistent with the definition of \dot{x}. The reciprocal product of screws $₁ and $₂ is given by $₁^{T}$₂, where for a general screw $=[s₁s₂s₃s₄s₅s₆]^{T} and its transpose $^{T}=[s₄s₅s₆s₁s₂s₃]. Using this definition, the components of ŨₓWₑ are interpreted as reciprocal products (uₓⁱ)^{T}Wₑ (i=1,2). If a wrench Wₑ is reciprocal to uₓⁱ for i=1,2, sensing Wₑ may not occur; otherwise, Wₑ affects the joint level forces τ and it is sensible. Based on this analysis, the decomposition of Wₛ into W_{sb} and W_{isb} can be obtained from equation 29.

W_{sb}^{T}uₓⁱ≠0 and W_{isb}^{T}uₓⁱ=0 for i=1,2 (29)

From equation 29, it can be shown that the insensible wrenches W_{isb} belong to a four-dimensional wrench system {W_{isb}} reciprocal to uₓⁱ for (i=1,2). The sensible wrenches W_{sb} belong to a two-dimensional wrench system that is reciprocal to uₓⁱ for (i=3, . . . , 6). From equations 25 and 28, one can develop equation 30 where Nul(A) is null space of A.

{W_{isb}}=Nul(J_{xψ}^{T}) (30)

uₓⁱ can be rewritten in Plücker ray coordinates as in equation 31 where [\hat{n}^{T},(r₀×\hat{n})^{T}]^{T} is the Plücker coordinates of the screw axis and λ is its pitch.

$$\text{?} = {κ}_{s} [ \begin{matrix}\hat{n} \\ {r}_{0} \times \hat{n} + λ \hat{n}\end{matrix} ] \\ \text{?} \text{indicates text missing or illegible when filed} \qquad ( 31 )$$

uₓⁱ can then be visualized as a line segment of [\hat{n}^{T},(r₀×\hat{n})^{T}]^{T} with its length equal to λ, starting from a point r₀ that is expressed in a coordinate system parallel to BDS and centered at the center of the end disk. The linear combinations of uₓⁱ for (i=1,2) can be visualized as a rank-2 screw system (cylindroid). This cylindroid can represent the sensible wrenches W_{sb}. At the same time, the basis wrenches that span the insensible wrench space {W_{isb}} can also be visualized.

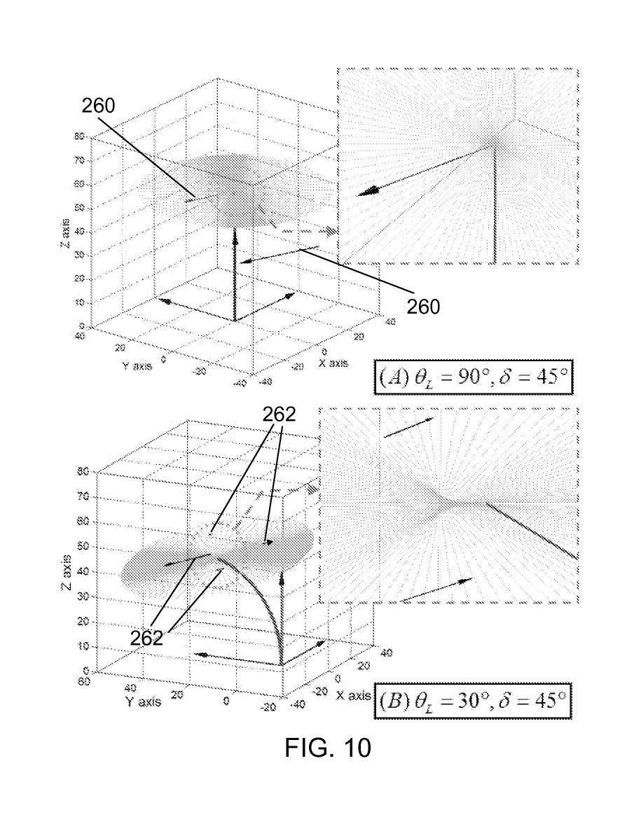

An exemplary simulation of a one segment robot for two different cases is provided to further describe force sensing. The dimensions and the elasticity parameters of the simulated continuum robot are given in table 2 below, where dₒₚ, dₒₛ, dᵢₚ and dᵢₛ designate the outer and inner diameters for primary and secondary backbones, respectively. In the first case study: ψ=[θ_{L}=90° δ=45°]^{T}. FIG. 10A illustrates the robot in a straight position in the first case study in accordance with some embodiments. In a second case study: ψ=[θ_{L}=30° δ=45°]^{T} FIG. 10B illustrates the robot in a curved position in the second case study, in accordance with certain embodiments. FIGS. 10A and 10B show the pencil of sensible wrenches indicated by lines and the basis for the 4-dimensional insensible wrenches shown by black arrows. The numerical values of J_{xψ}, Uₓ, Dₓ and Vₓ are listed in table 3 for the first and second case studies.

TABLE 2
Parameters of Robot

| | | |
|---|---|---|
| L = 50 mm | r = 3.0 mm | Eₚ = Eₛ = E = 62 GPa |

| | |
|---|---|
| dₒₚ = dₒₛ = 0.889 mm | dᵢₚ = dᵢₛ = 0.762 mm |

TABLE 3
Calculated Values

| | θ_{L} = 90°, δ = 45° | θ_{L} = 30°, δ = 45° |
|---|---|---|
| J_{xψ} | $[ \begin{matrix}- 19.4454 & 0 \\ 19.4454 & 0 \\ 0 & 0 \\ - 0.7071 & 0 \\ - 0.7071 & 0 \\ 0 & 0\end{matrix} ]$ | $[ \begin{matrix}- 14.4304 & - 18.5690 \\ 14.4304 & - 18.5690 \\ 17.1741 & 0 \\ - 0.7071 & 0.6124 \\ - 0.7071 & - 0.6124 \\ 0 & - 0.5000\end{matrix} ]$ |
| Uₓ | $[ \begin{matrix}- .7066 & .7066 & 0 & - .0257 & - .0257 & 0 \\ .7066 & .7074 & 0 & .0106 & .0106 & 0 \\ 0 & 0 & 1.0000 & 0 & 0 & 0 \\ - .0257 & .0106 & 0 & .9996 & - .0004 & 0 \\ - .0257 & .0106 & 0 & - .0004 & .9996 & 0 \\ 0 & 0 & 0 & 0 & 0 & 1.0000\end{matrix} ]$ | $[ \begin{matrix}- .5406 & - .7066 & .4551 & - .0039 & - .0336 & - .0121 \\ .5406 & - .7066 & - .4548 & .0368 & .0006 & - .0148 \\ .6434 & .0000 & .7654 & .0070 & .0124 & .0022 \\ - .0265 & .0233 & .0132 & .9993 & - .0004 & .0001 \\ - .0265 & - .0233 & .0061 & .0001 & .9994 & - .0003 \\ 0 & - .0190 & - .0029 & .0003 & - .0001 & .9998\end{matrix} ]$ |
| Vₓ | $[ \begin{matrix}1 & 0 \\ 0 & 1\end{matrix} ]$ | $[ \begin{matrix}1 & 0 \\ 0 & 1\end{matrix} ]$ |
| Dₓ | $[ \begin{matrix}diag ( 27.5182 , 0 ) \\ {0}_{4 \times 2}\end{matrix} ]$ | $[ \begin{matrix}diag ( 26.6912 , 26.2796 ) \\ {0}_{4 \times 2}\end{matrix} ]$ |

The case first case study further describes the insensible wrenches encountered with a single segment robot. One wrench (the third column in the corresponding Uₓ matrix in table 3) is [0 0 1 0 0 0]^{T}, which can be expressed as a screw with infinite pitch and doesn't appear in FIG. 10A. This wrench is a pure force in the Z direction, and is insensible because the primary backbone is fixed to the base disk in this embodiment without monitoring the force on this backbone. In embodiments where the force on the primary backbone is measured, this wrench is sensible.

A second wrench (the sixth column in the corresponding Uₓ matrix in table 3) is [0 0 0 0 0 1]^{T}, which can be expressed as a screw with zero pitch and doesn't appear in FIG. 10A either. The second wrench is a pure moment in the Z direction and is insensible because in this embodiment, the moment about \hat{z}ₑ does not affect backbone actuation. In other robot configurations, this second wrench may be sensible. Further, the two arrows in FIG. 10A illustrate the force-moment combinations 260, which generate zero changes of the actuation forces on the backbones. These two arrows are found in the fourth and fifth column in the corresponding Uₓ matrix in table 3. When the robot in this embodiment is straight, the force along \hat{z}_{b} and the moment about \hat{z}_{b} can't be sensed. The sensible cylindroid appears as a flat pencil within the XY plane, as shown in FIG. 10A, compared with the finite pitch cylindroid in FIG. 10B. In the case studies, matrix Dₓ degrades to rank 1.

FIG. 10B illustrates four wrenches (the third to sixth column in Uₓ of table 3). These four wrenches (black arrows) 262 represent the basis for the insensible wrench space. The sixth column is close to the wrench [0 0 0 0 0 1] ^{T}, which makes it difficult to show in FIG. 10B. As a result, in some embodiments, the moment about the \hat{z}ₑ may be difficult to estimate. The sensible wrenches (the first and second column in the corresponding Uₓ matrix in table 3) can form a two-dimensional cylindroid with a finite pitch in the second case study.

The force sensing model may be validated through testing. In a first test calibration weights can be used to apply forces at the end disk of a single segment robot. In a second test a single segment robot can be used to detect the stiffness of a flexible silicone strip that serves as a mockup tissue. In the first test, a Kevlar thread is attached to the tip of the robot so that a pure force can be applied. The force is applied through a frictionless pulley, using calibrated weights. The pulley is mounted to an aluminum frame, which is set such that the applied force is always parallel to the XY plane of BDS. A marker is aligned with the Kevlar thread to measure the direction of the applied force using an optical tracker. The actuation unit of the robot was repositioned when the robot was bent to different θ_{L} values in order to keep the force parallel to the XY plane of the BDS.

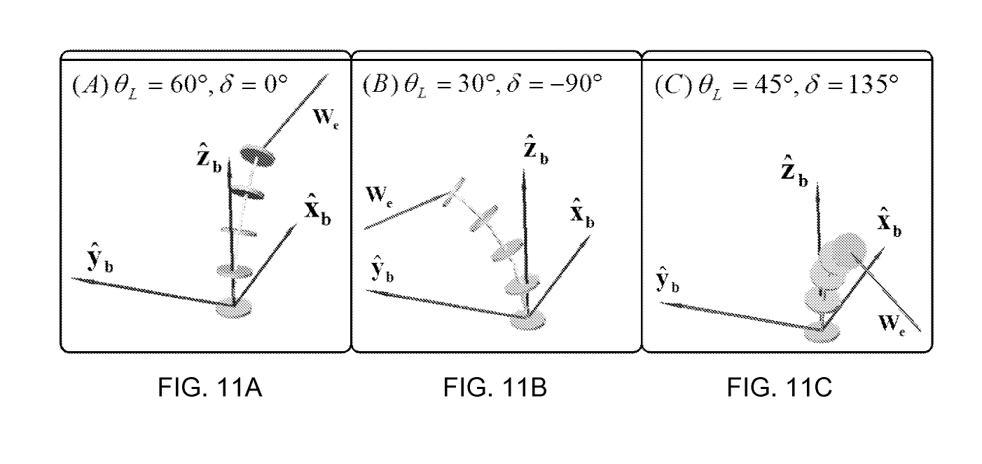

The robot can be bent to different configurations in the first test. Under each configuration, known forces (Wₑ in FIGS. 11A, B and C) were applied at the center of the end disk. The applied force varies from 5.4 grams to 55.4 grams in the increment of 10 grams. In some embodiments, the actuation forces on the secondary backbones were monitored using Omega LC703 load cells coupled with a 12 bit analog-to-digital converter (A/D converter) at ±0.01V measurement range. This testing setup allowed an actuation force measurement with a resolution of ±0.5 grams. However, since there is some small friction in the reading, the actual resolution may differ.

Since the applied force on the end disk was parallel to the XY plane of the BDS, this known condition information can be used in equation 17 to obtain the best estimate of the sensed wrench Wₛ, in certain embodiments. Equation 19 can be solved with Sₑ=diag(0,0,1,1,1,1) and Wₛₑ=[1 1 0 0 0 0]^{T}. The test results are listed in table 4. The table lists the averages of the three test results and the corresponding errors. Among the error values, the average was 0.34 grams with a standard deviation of 0.83 grams. The design of the robot, in some embodiments, can provide a precision of 0.34±0.83 grams when the actual resolution is ±10 grams with joint level force monitoring. Substituting equation 24 into equation 17, the magnitude of τ as well as its reading uncertainty Δτ can be reduced by a factor from \tilde{D}ₓ, since Uₓ and Vₓ^{T} are both orthogonal matrices. Referring to the diagonal values of Dₓ in table 2, the factor is about 27, which means, an error of 0.34±0.83 grams is equivalent to about 9.18±22.41 grams at the joint level reading errors.

TABLE 4
Test 1 Results

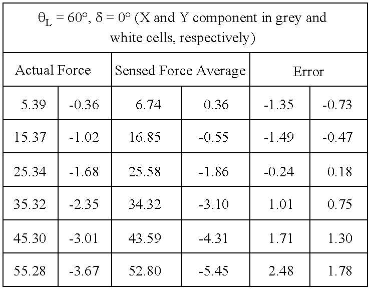 [SMILES: C1CC2CC3CC4CC1C1C5C6C7C8C9CC%10C%11C%12C%13C%14CC%15C%16C%17C%18C%19C2C2C3%20C3C4%21C1C51C64C75C86C%109C%117C%128C%139C%14%15C%16%10C%17%11C%18%12C%192C%202C3%13C%211C41C53C76C84C9%10C%115C%122C%131C435]

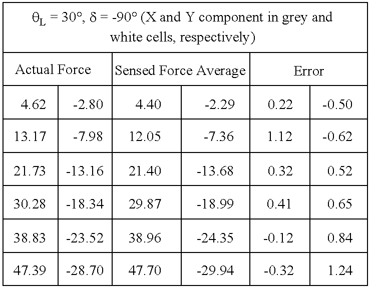 [SMILES: C1CC2CC3CC4CC1C1C5C6C7C8C9CC%10C%11C%12C%13C%14CC%15C%16C%17C%18C%19C2C2C3%20C3C4%21C1C51C64C75C86C%109C%117C%128C%139C%14%15C%16%10C%17%11C%18%12C%192C%202C3%13C%211C41C53C76C84C9%10C%115C%122C%131C435]

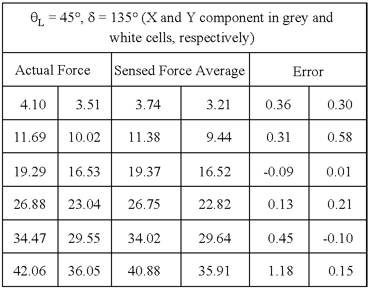 [SMILES: C1CC2CC3CC4CC1C1C5C6C7C8C9CC%10C%11C%12C%13C%14CC%15C%16C%17C%18C%19C2C2C3%20C3C4%21C1C51C64C75C86C%109C%117C%128C%139C%14%15C%16%10C%17%11C%18%12C%192C%202C3%13C%211C41C53C76C84C9%10C%115C%122C%131C435]

In the second test, a silicone strip was molded with three steel balls embedded in it. The ball diameters were 6.34 mm, 9.51 mm and 12.69 mm respectively. The steel balls were embedded at a depth of 0.5 mm from the probed surface in some embodiments. The silicone strip was probed using a single segment robot with a probing depth of 0.5 mm. A Cartesian XYZ stage can be used to adjust the position of the silicone strip so that the workspace of the continuum robot can cover the entire surface of this silicone strip. The surface was scanned in 1 mm increments both in length and in width directions. The stiffness value on a probed point was calculated as the ratio of resistance force over probed depth of 0.5 mm. The resistance force can be calculated with Sₑ=diag(0,0,1,1,1,1) and Wₛₑ=[1 1 0 0 0 0]^{T}, since the resistance force is normal to the surface of the silicone strip, which is parallel to \hat{x}_{b}.

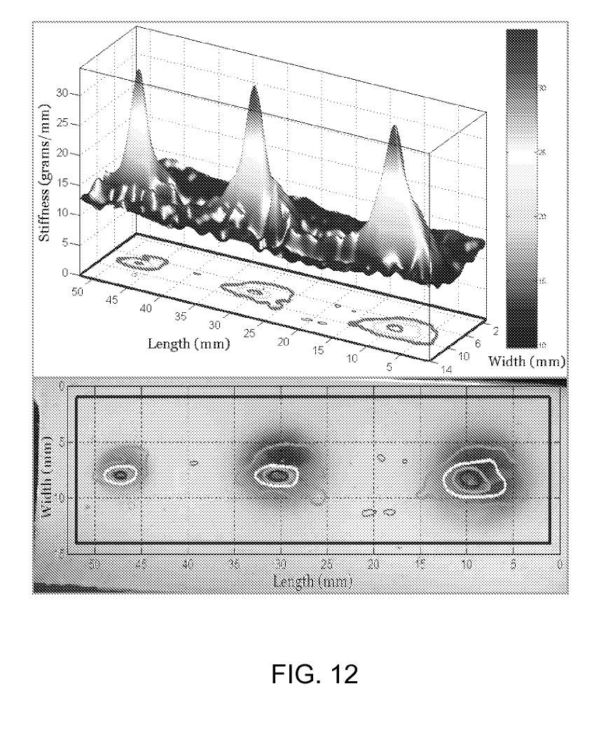

An entire surface stiffness map can be generated using spline interpolation, as shown in FIG. 12 in accordance with certain embodiments. In FIG. 12, the contour of the surface stiffness map is overlaid beneath the stiffness surface as well as on top of the real silicone strip. In FIG. 12, the three stiffness peaks correspond to the three embedded balls. It can be seen from the different slopes of the peaks and different sizes of the stiffness contours that the three balls are different in size. The same height of the three stiffness peaks for all three balls means that the balls are embedded at approximately the same depth. In this test, the silicone was not probed deep enough to induce large motion of the balls inside the silicone. As such, the resistance force sensed by robot can come from the local surface deformation of the silicone strip. In some embodiments, the force sensing sensitivity of the robot provides the ability to detect not only the shape but also the depth of embedded objects. Some of the noise seen in FIG. 12 is the result of using low cost silicone, the stiffness of which is not uniform, and can cause tiny spikes in the readings.

Since the force and moment of the robot are calculated indirectly from other sensory information, some calibrations may be made to the calculations. For example, the angle of the primary backbone θ_{L} may differ from a model of this angle. The Jacobian matrices J_{xψ} and J_{qψ} depend on the bending shape of the robot, and can be calibrated to improve the accuracy of the calculations. The bending shape of the robot may differ from robot to robot based on the manufacturing tolerances of the robots. For example, a calibration for J_{qψ} actual measured values versus modeled values of θ_{L} and a linear regression was used to determine the calibration factor. The calibration equation 32 shows this result where θ̅_{L} is the desired end effector value, κ is a modification factor and θ_{C} is used to keep the straight configuration of the robot defined as θ_{L}=π/2. Based on the calibration, equation 1 is modified to equation 33 and J_{qψ} is modified in equation 34.

$$\begin{matrix} {\overline{θ}}_{L} = κ {θ}_{L} - {θ}_{c} & ( 32 ) \\ {L}_{i} = L + {q}_{i} = L + {Δ}_{i} ( ( κ {θ}_{L} - \text{?} ) - {θ}_{0} ) & ( 33 ) \\ \text{?} = [ \begin{matrix}κ r cos ( δ ) & - r ( κ {θ}_{L} - \text{?} - {θ}_{0} ) sin ( δ ) \\ κ r cos ( δ + 2 π / 3 ) & - r ( κ {θ}_{L} - {θ}_{c} - {θ}_{0} ) sin ( δ + 2 π / 3 ) \\ κ r cos ( θ + 4 π / 3 ) & - r ( κ {θ}_{L} - {θ}_{c} - {θ}_{0} ) sin ( δ + 4 π / 3 )\end{matrix} ] \\ \text{?} \text{indicates text missing or illegible when filed} & ( 34 )\end{matrix}$$

The calibration of equation 33 can also lead to modifications in the statics calculations for the robot. Equations 10 and 13 can be updated using equation 33. The gradient of the elastic energy ∇E is updated in equation 35 using Lᵢ from equation 33.

$$∇ E = [ \begin{matrix}\begin{matrix}( {θ}_{L} - {θ}_{a} ) ( \frac{\text{?}}{L} + \text{?} \frac{\text{?}}{\text{?}} ) - \\ \frac{{( {θ}_{L} - {θ}_{0} )}^{2}}{2} \text{?} r \text{?} \frac{κ cos {δ}_{i}}{{L}_{i}^{2}}\end{matrix} \\ \frac{{( {θ}_{L} - {θ}_{0} )}^{2}}{2} \text{?} r \text{?} \frac{sin {δ}_{i} ( κ {θ}_{L} - {θ}_{c} - {θ}_{0} )}{{L}_{i}^{2}}\end{matrix} ] \\ \text{?} \text{indicates text missing or illegible when filed} \qquad ( 35 )$$

Force sensing at the end effector of a robot can be provided based on the singular value decomposition (SVD) of a Jacobian matrix that maps speeds from a two dimensional configuration space to twists in a six-dimensional space. Using the SVD yields a four dimensional wrench system for wrenches that cannot be sensed by force sensors, and yields a two-dimensional cylindroid for the wrenches that are sensible with joint-level information. A force sensing algorithm is also presented that accounts for external information coming from knowledge about some components of the external wrench or from other sensor measurements.

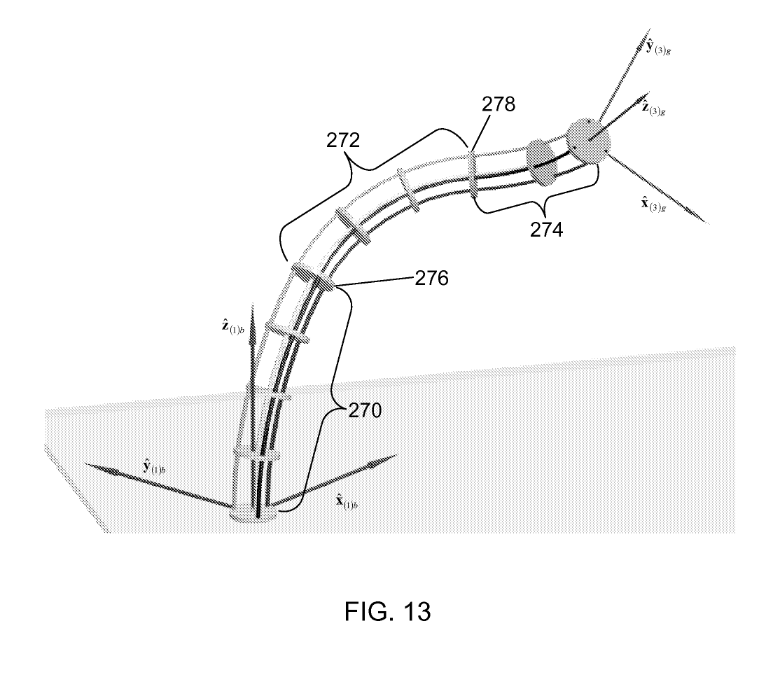

As described above, the continuum robot can be constructed with a number of independently controlled segments. The following provides an algorithm which modifies the algorithm for force sensing in a one or two segment robot for a robot with three or more segments. FIG. 13 illustrates a three segment robot with corresponding coordinate references in accordance with some embodiments. In order to provide an explanation of force sensing for three or more segments, additional nomenclature is defined for the following equations. The nomenclature also adopts a subscript t to identify the t^{th} segment of the robot. For example, the most proximal segment 270 of the three segments is labeled {\hat{x}_{(1)g},ŷ_{(1)g},\hat{z}_{(1)g}}, the second segment 272 is labeled {\hat{x}_{(2)g},ŷ_{(2)g},\hat{z}_{(2)g}} (not shown in FIG. 13), and the most distal third segment 274 is labeled {\hat{x}_{(3)g},ŷ_{(3)g},\hat{z}_{(3)g}}. Further, the end disk 276 of segment 270 is the base disk 276 or segment 272 and the end disk 278 of segment 272 is the base disk 278 of segment 274 for the purposes of calculating force sensing measurements. The base disk coordinate system (BDS), the bending plane coordinate system (BPS), the end disk coordinate system (EDS) and the gripper coordinate system (GCS), as described above, are used to describe the coordinates of the t segments of the robot. As such, due to the interconnection of multiple segments, {\hat{x}_{(t)g},ŷ_{(t)g},\hat{z}_{(t)g}} is identical to {\hat{x}_{(t+1)b}, ŷ_{(t+1)b},\hat{z}_{(t+1)b}}. Table 5 is used to provide additional nomenclature used in the following analysis.

TABLE 5
Nomenclature for a Multiple Segment Robot

| | |
|---|---|
| t | Index of the segments, t = 1, 2, . . . , n. |
| I₍ₜ₎ₚ, I₍ₜ₎ₛ | Cross-sectional moments of inertia of the primary and the secondary |
| | backbones for the t^{th} segment |
| L₍ₜ₎, L₍ₜ₎ᵢ | Length of the primary and the i^{th} secondary backbone for the i^{th} segment |
| d₍ₜ₎ₚₒ, d₍ₜ₎ₛₒ | The outer and inner diameters of the primary backbone and the secondary |
| d₍ₜ₎ₚᵢ, d₍ₜ₎ₛᵢ | backbones for the t^{th} segment, respectively. |
| q₍ₜ₎ | q₍ₜ₎ = [q₍ₜ₎₁ q₍ₜ₎₂ q₍ₜ₎₃]^{T} is the actuation length vector in the joint space for the |
| | t^{th} segment, where q₍ₜ₎ᵢ = L₍ₜ₎ᵢ − L₍ₜ₎. |
| θ₍ₜ₎(s) | The angle of the tangent to the primary backbone in the bending plane for |
| | the t^{th} segment. θ(L₍ₜ₎) and θ(0) are designated by θ_{(t)L} and θ₀ · θ₀ = π/2 is a |
| | constant. |
| δ₍ₜ₎ᵢ | For the t^{th} segment, a right-handed rotation angle from \hat{x}₍ₜ₎₁ about \hat{z}₍ₜ₎₁, to a |
| | line passing through the primary backbone and the i^{th} secondary |
| | backbone. At a straight configuration \hat{x}₍ₜ₎₁ is along the same direction as |
| | the desired instantaneous linear velocity of the end disk. |
| δ₍ₜ₎ | δ₍ₜ₎ ≡ δ₍ₜ₎₁ and δ₍ₜ₎ᵢ = δ₍ₜ₎ + (i − 1)β, i = 1, 2, 3 |
| ψ₍ₜ₎ | ψ₍ₜ₎ = [θ_{(t)L} δ₍ₜ₎]^{T} is a configuration vector to define the pose of the t^{th} |
| | segment of the robot. |
| τ₍ₜ₎ | τ₍ₜ₎ ⁼ [τ₍ₜ₎₁ τ₍ₜ₎₂ τ₍ₜ₎₃]^{T} is the actuation force vector of the secondary |
| | backbones for the t^{th} segment. |
| J_{(t)xψ} | \dot{x}₍ₜ₎ = J_{(t)xψ}\dot{ψ}₍ₜ₎ where \dot{x}₍ₜ₎ is the twist of the end disk of the t^{th} segment in |
| | {\hat{x}_{(t)b}, ŷ_{(t)b}, \hat{z}_{(t)b}}. In \dot{x}₍ₜ₎, the linear velocity precedes the angular velocity. |
| J_{(t)qψ} | Jacobian matrix of the mapping \dot{q}₍ₜ₎ = J_{(t)qψ}\dot{ψ}₍ₜ₎ |
| ∇E₍ₜ₎ | Elastic energy gradient for the t^{th} segment |
| Jₙₓ | Overall Jacobian for one n-segment continuum robot where \dot{x} = Jₙₓ\dot{ψ}ₙ, |
| | ψₙ = [ψ₍₁₎^{T} ψ₍₂₎^{T} . . . ψ₍ₙ₎^{T}]^{T} and \dot{x} is the twist of the end disk of the n^{th} |
| | segment in {\hat{x}_{(1)b}, ŷ_{(1)b}, \hat{z}_{(1)b}}. |
| ^{(t)b}p₍ₜ₎(s) | Position vector of a point along the primary backbone and the i^{th} |
| ^{(t)b}p₍ₜ₎ᵢ(s) | secondary backbone in the t^{th} segment tip in {\hat{x}_{(t)b}, ŷ_{(t)b}, \hat{z}_{(t)b}}. ^{(t)b}p₍ₜ₎(L₍ₜ₎) is the |
| | tip position of the t^{th} segment, which is designated by ^{(t)b}p_{(t)L}. |
| ĝ | Unit vector for the direction of the gravity |

As FIG. 13 shows, segments can be stacked to form a robot with more degrees of freedom in accordance with certain embodiments. The actuation elements of the segments can be concentric backbones. For a n-segment continuum robot, its configuration can be characterized by ψₙ=[ψ₍₁₎^{T} ψ₍₂₎^{T} . . . ψ₍ₙ₎^{T}]^{T} and its kinematics can be obtained by deriving the linear and the angular velocities of the end disk using J_{(t)xψ}, t=1, 2, . . . , n. For n=2, or a two segment robot, the linear and the angular velocities can be written as shown in equations 36 and 37.

^{(1)b}v=J_{(1)vψ}\dot{ψ}₍₁₎+(J_{(1)ωψ}\dot{ψ}₍₁₎)×^{(1)b}p_{(2)L}+^{(1)b}R_{(2)b}J_{(2)vψ}\dot{ψ}₍₂₎ (36)

^{(1)b}ω=J_{(1)ωψ}\dot{ψ}₍₁₎+^{(1)b}R_{(2)b}J_{(2)ωψ}\dot{ψ}₍₂₎ (37)
Where ^{(1)b}p_{(2)L}=^{(1)b}R_{(2)b}^{(2)b}p_{(2)L}

Since (J_{(1)ωψ}\dot{ψ}₍₁₎)×^{(1)b}p_{(2)L}=−S(^{(1)b}p_{(2)L})J_{(1)ωψ}\dot{ψ}₍₁₎, where S(p) is the skew-symmetric matrix of a vector p, the Jacobian matrix of a 2-segment continuum robot is given in equation 38.

$${}^{( 1 ) b} \dot{x} = {J}_{2} {\dot{ψ}}_{2} = {{J}_{2} [ \begin{matrix}{\dot{ψ}}_{( 1 )}^{T} & {\dot{ψ}}_{( 2 )}^{T}\end{matrix} ]}^{T} \\ Where {J}_{2 x} = [ \begin{matrix}{J}_{( 1 ) v ψ} - S ( {}_{}^{( 1 ) b}{p}{}_{( 2 ) L}^{} ) {J}_{( 1 ) ω ψ} & {}_{}^{( 1 ) b}{R}{}_{( 2 ) b}^{} {J}_{( 2 ) v ψ} \\ {J}_{( 1 ) ω ψ} & {}_{}^{( 1 ) b}{R}{}_{( 2 ) b}^{} {J}_{( 2 ) ω ψ}\end{matrix} ] . \qquad ( 38 )$$

Similarly, for n=3, or a three segment robot, the Jacobian can be derived by equations 39 and 40.

$$\begin{matrix}{}^{( 1 ) b} \dot{x} = {J}_{3} {\dot{ψ}}_{3} = {{J}_{3} [ \begin{matrix}{\dot{ψ}}_{( 1 )}^{T} & {\dot{ψ}}_{( 2 )}^{T} & {\dot{ψ}}_{( 3 )}^{T}\end{matrix} ]}^{T} & ( 39 ) \\ {J}_{3 x} = [ \begin{matrix}{T}_{1} & {}_{}^{( 1 ) b}{R}{}_{2 ( b )}^{} {T}_{2} & {}_{}^{( 1 ) b}{R}{}_{( 3 ) b}^{} {J}_{( 3 ) v ψ} \\ {J}_{( 1 ) ωψ} & {}_{}^{( 1 ) b}{R}{}_{( 2 ) b}^{} {J}_{( 2 ) ω ψ} & {}_{}^{( 1 ) b}{R}{}_{( 3 ) b}^{} {J}_{( 3 ) ω ψ}\end{matrix} ] & ( 40 )\end{matrix}$$

Where the components of the Jacobian of equation 40 can be given by equations 41 and 42.

T₁=J_{(1)vψ}−S(^{(1)b}p_{(2)L}+^{(1)b}p_{(3)L})J_{(1)ωψ} (41)

T₂=J_{(2)vψ}−S(^{(2)b}p_{(3)L})J_{(2)ωψ} (42)

^{(2)b}p_{(3)L}=^{(2)b}R_{(3)b}^{(3)b}p_{(3)L}, ^{(1)b}R_{(3)b}=^{(1)b}R_{(2)b}^{(2)b}R_{(3)b} and ^{(1)b}p_{(3)L}=^{(1)b}R_{(2)b}^{(2)b}R_{(3)b}^{(3)b}p_{(3)L}

As was described above for the single segment robot, the algorithm for force sensing can be developed based on a virtual work model. In some embodiments, twisting, friction, and extension of the backbones is neglected from the algorithm. For a n-segment robot, an external wrench Wₑ=[fₑ^{T} mₑ^{T}]^{T} acts on the end disk of the distal (the nth) segment, where fₑ indicates the force and mₑ the moment. This external wrench perturbs the robot posture (position and orientation) of the end disk by Δx, which caused by a corresponding change in the lengths of the secondary backbones, Δqₙ. The actuation forces on the secondary backbones of all the segments which maintain the equilibrium are τₙ=[τ₍₁₎^{T} τ₍₂₎^{T} . . . τ₍ₙ₎^{T}]^{T}. The change in the potential energy ΔE that corresponds to Δx is given by equation 43 (which corresponds to equation 11 for a single segment robot).

Wₑ^{T}Δx+τ^{T}Δqₙ=ΔE (43)

Where qₙ is the actuation length vector for the n-segment robot and

$${q}_{n} ≡ {[ \begin{matrix}{q}_{( 1 )}^{T} & {q}_{( 2 )}^{T} + {q}_{( 2 )}^{T} & … & {\sum }_{t = 1}^{n} {q}_{( t )}^{T}\end{matrix} ]}^{T} ,$$

the actuation length vector gives the displacement of each of the secondary backbones for each segment of the n-segment robot. Δqₙ can be characterized by Δψₙ as equation 44, using equation 8.

$$Δ {q}_{n} = {J}_{nq} Δ {ψ}_{n} \\ Where {J}_{nq} = [ \begin{matrix}{J}_{( 1 ) q ψ} & {0}_{3 \times 2} & … & {0}_{3 \times 2} \\ {J}_{( 1 ) q ψ} & {J}_{( 2 ) q ψ} & … & {0}_{3 \times 2} \\ ⋮ & ⋮ & ⋱ & ⋮ \\ {J}_{( 1 ) q ψ} & {J}_{( 2 ) q ψ} & … & {J}_{( n ) q ψ}\end{matrix} ] \qquad ( 44 )$$

The virtual displacement Δx can also be characterized by Δψₙ in equation 45. Using equation 45, the virtual work principle can be rewritten in equation 46. To achieve an equilibrium condition, the terms associated with each independent degree of freedom (DOF) should vanish. The matrix form of this system of linear equations is given in equation 47 where ∇Eₙ represents the gradient of the elastic energy with respect to the configuration perturbation Δψₙ of a n-segment robot.

Δx=JₙₓΔψₙ (45)

Wₑ^{T}JₙₓΔψₙ+τₙ^{T}J_{nq}Δψₙ=∇Eₙ^{T}Δψₙ (46)

J_{nq}^{T}τₙ+Jₙₓ^{T}Wₑ=∇Eₙ (47)

The total potential energy Eₙ of the n-segment continuum robot includes the gravitational energy and the elastic energy generated from the segments' bending as shown in equation 48. In equation 48, ρ₍ₜ₎ and ρ₍ₜ₎ᵢ are the mass per unit length along the primary backbone and the secondary ith backbone, ^{(1)b}ĝ is ĝ expressed in {(\hat{x}_{(1)b},ŷ_{(1)b},\hat{z}_{(1)b}}, and ^{(1)b}p₍ₜ₎(s) and ^{(1)b}p₍ₜ₎ᵢ(s) are position vector along the primary backbone and the secondary ith backbone in {\hat{x}_{(1)b},ŷ_{(1)b},\hat{z}_{(1)b}}. Additionally, the zero point of the gravitational potential energy can be set at the origin of {\hat{x}_{(1)b},ŷ_{(1)b},\hat{z}_{(1)b}}. ∇Eₙ can be obtained by taking derivative of 48 with respect to ψₙ.

$${E}_{n} = {\sum }_{t = 1}^{n} ( \begin{matrix}{\int }_{0}^{{L}_{( t )}} ( \begin{matrix}\frac{{E}_{p} {I}_{( t ) p}}{2} {( \frac{{θ}_{( t )}}{d s} )}^{2} + \\ {ρ}_{( t )} ( {\sum }_{j = 1}^{t - 1} ( {}_{}^{( 1 ) b}{p}{}_{( j ) L}^{} ) + {}_{}^{( 1 ) b}{p}{}_{( t )}^{} ( s ) ) \cdot {}^{( 1 ) b} \hat{g}\end{matrix} ) d s + \\ {\sum }_{i = 1}^{3} {\int }_{0}^{{L}_{( t ) i}} ( \begin{matrix}\frac{{E}_{s} {I}_{( t ) s}}{2} {( \frac{{θ}_{( t )}}{d s} )}^{2} + \\ {ρ}_{( t ) i} ( {\sum }_{j = 1}^{t - 1} ( {}_{}^{( 1 ) b }{p}{}_{( j ) iL}^{} ) + {}_{}^{( 1 ) b}{p}{}_{( t ) i}^{} ( s ) ) \cdot {}^{( 1 ) b} \hat{g}\end{matrix} ) d s\end{matrix} ) \qquad ( 48 )$$

Force and moment sensing on the robot can be provided by returning to equation 16, as described for the single segment robot. Equation 49 below shows equation 16 rewritten for use with a n-segment robot.

Jₙₓ^{T}Wₑ=∇Eₙ−J_{nq}^{T}τₙ (49)

When the rank of Jₙₓ^{T} is equal to six, the general solution of equation 49 can be written as equation 50, where Wₛ stands for the sensed external wrench and where (Jₙₓ^{T})⁺ equals (Jₙₓ^{T})⁻¹, if Jₙₓ^{T} is square. If Jₙₓ^{T} is not square, the (Jₙₓ^{T})⁺=(JₙₓJₙₓ^{T})⁻¹Jₙₓ. In calculating equation 50 of robots of three or more segments, the processor can use measurements of force and displacement of the backbones of the various segments to calculate the force and moment at the distal end of the robot.

Wₛ=(Jₙₓ^{T})⁺(∇Eₙ−J_{nq}^{T}τₙ) (50)

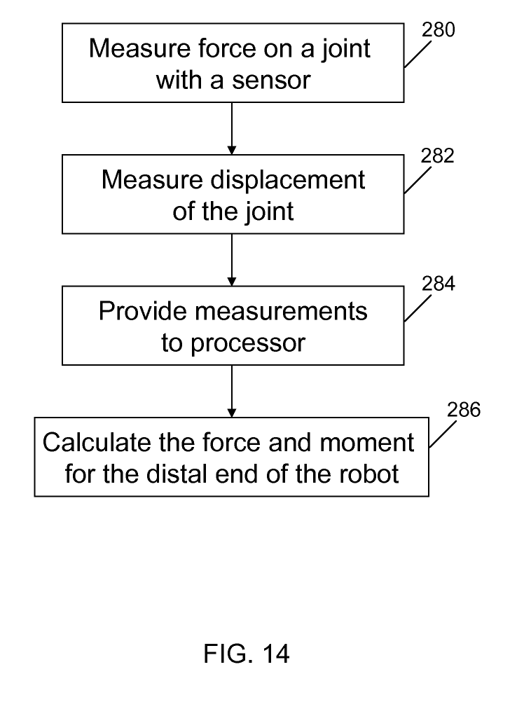

FIG. 14 illustrates a chart for providing force sensing in a robot in accordance with certain embodiments. The robot can be any design that includes a joint with axial stiffness. For example, the joint can be a rod, a backbone, or any other member. The joint is coupled with a sensor that measures the force placed on the joint. The joint can be coupled at the distal end of the joint with an end disk, which can be designed to probe or can be designed for tool attachment. The end disk need not be circular in some embodiments. The displacement of the joint, which is the amount the joint is pushed or pulled can also be measured. The displacement can be measured by a processor, by an actuating device moving the joint, or by a sensor.

In reference 280, a sensor measures the force on the joint. The measurements may be in analog or digital form. If an analog signal is provided by the sensor, an analog-to-digital converter (A/D converter) can be used to convert the analog signal to a digital signal. The measurement can be made at the proximal end of the robot in some embodiments. In reference 282, the displacement of the joint is measured. In reference 284, the force measurement and the displacement measurement is provided to a processor that is in operable communication with the sensor. The processor can store the measurements and calculations in a computer readable medium. In reference 286, the processor uses the force and displacement measurements to perform a calculation to determine the force and moment at the distal end of the robot. The force and moment calculations performed by the robot indirectly sense the force and moment acting on the distal end of the robot, even though there is no force sensor at the distal end of the robot. The force and moment can be used to provide information for use in a palpation, an incision, or a suture penetration, for example.

The ability of a robot to be utilized for force sensing can be determined by a performance index. The performance index can provide an indication of a robot's force sensing capability. The disclosed intrinsic wrench sensing approach can treat the entire robot structure as one force sensor, so the performance index can be extended from an evaluation index for sensor designs. In some embodiments, a model for a multiple-axis force sensor can be presented as v=Cu or Mv=MCu, where v is the transducer output vector, u is the applied external wrench, C is a constant compliance matrix characterizing the force sensor, and M is a projection matrix to deal with redundant force sensors. Redundant force sensors can be sensors with more transducer outputs than the minimal required number. From this a sensing equation for a multiple-axis force sensor can be obtained in equation 51.

u=C⁻¹v or u=(MC)⁺Mv (51)

In evaluating force sensor design a condition number, N_{C} of C or N_{MC} of MC, is used to determine the relative performance of the design. A small N_{C} or N_{MC} value is typically indicative of a good design for two reasons: i) better isotropic measurements among the sensed components, and ii) sensing errors on u will be bounded as shown in equation 52.

$${ɛ}_{u} \leq \frac{{N}_{C}}{1 - {N}_{C} {ɛ}_{C}} ( {ɛ}_{v} + {ɛ}_{C} ) \qquad ( 52 )$$

Where εᵤ=∥δu∥/∥u∥ is errors upper bound of the sensed results, εᵥ=∥δv∥/∥v∥ is the data acquisition error bound for the transducers, and ε_{C}=∥δC∥/∥C∥ is the calibration errors for matrix C.

The expression in equation 51 for a conventional force sensor is similar to the wrench sensing equations in 17 and 50, where measurements τₙ are projected to form Wₛ. By basing the formulation of a performance index for a robot's force sensing on equation 50, equation 53 is obtained for determining error analysis.

εₛ=(Jₙₓ^{T})⁺ε_{∇E}+(Jₙₓ^{T})⁺J_{nq}^{T}ε_{τ} (53)

Where εₛ is the wrench sensing error, ε_{∇E} is the modeling error of ∇Eₙ, and ε_{τ} is the measurements errors of τₙ. Since ε_{∇E} can be calibrated, analyzing the feasibility of a robot's force sensing capabilities an important factor is (Jₙₓ^{T})⁺J_{nq}^{T}ε_{τ}. The Singular Value Decomposition of (Jₙₓ^{T})⁺J_{nq}^{T} can be rewritten to provide the performance of the intrinsic wrench sensing in equation 54.

(Jₙₓ^{T})⁺J_{nq}^{T}=UₙDₙVₙ^{T} (54)

Equation 54 includes Uₙ and Vₙ, which are both unitary orthogonal matrices and Dₙ, which is a matrix of singular values. Focusing on the estimation error vector ε_{τ}, eigenvalues from Dₙ can determine how these errors from ε_{τ} will be bounded. This is because Uₙ and Vₙ are unitary orthogonal matrices, so they do not change the norm of the estimation error vector ε_{τ}. Looking at the eigenvalues from Dₙ, these eigenvalues impact the measurement errors from τₙ, and can be useful in developing a performance index. From equation 54, the Frobenius norm is taken of (Jₙₓ^{T})⁺J_{nq}^{T}, which associates the task space with the joint space and quantifies an upper bound of the wrench sensing errors from force sensor measurement errors. A performance index χ is shown in equation 55. This performance index can be used to determine the force sensing capabilities of robot. The performance index χ provides a metric that quantifies the haptic or force sensing ability of robot. In evaluating a robot, a performance index value that is less than one indicates a robot where the force sensing abilities of the robot can be more precise than the resolution of the force sensor. Performance index values that are greater than one indicate the force sensing abilities of the robot can be less precise than the resolution of the force sensor. For example, for an index value of 2.5, the robot can magnify the error of the force sensors by 2.5 times.

χ_{Continuum}=∥(Jₙₓ^{T})⁺J_{nq}^{T}∥_{F} (55)

In some embodiments, the Frobenius norm can be calculated by using

$${‖ A ‖}_{F} = \sqrt{{{\sum }_{i = 1}}^{m} {\sum }_{j = 1}^{n} {\vert {a}_{ij} \vert}^{2}} ,$$

which shows the Frobenius norm of matrix A. In some embodiments, it may be desirable to calculate the performance index using one of the following formulations:

$${‖ {( {J}_{nx}^{T} )}^{+} {J}_{nq}^{T} ‖}_{F} = {‖ {U}_{n} {D}_{n} {V}_{n}^{T} ‖}_{F} = \sqrt{{\sum }_{i = 1}^{6} {d}_{i}^{2}} ,$$

where dᵢ are the singular values from Dₙ.

The performance index χ developed above can provide an implementation guide for robots in which force sensing or haptics is planned to be implemented. The performance index provides designers with an algorithm in which to determine the haptic or force sensing resolution of a robot. A designer can use the performance index to select a force sensor that will provide the desired precision and accuracy based on the robot design selected and the force sensors selected. The evaluative ability of the performance index is further described below with the simulation of a continuum robot and a Stanford Manipulator robot.

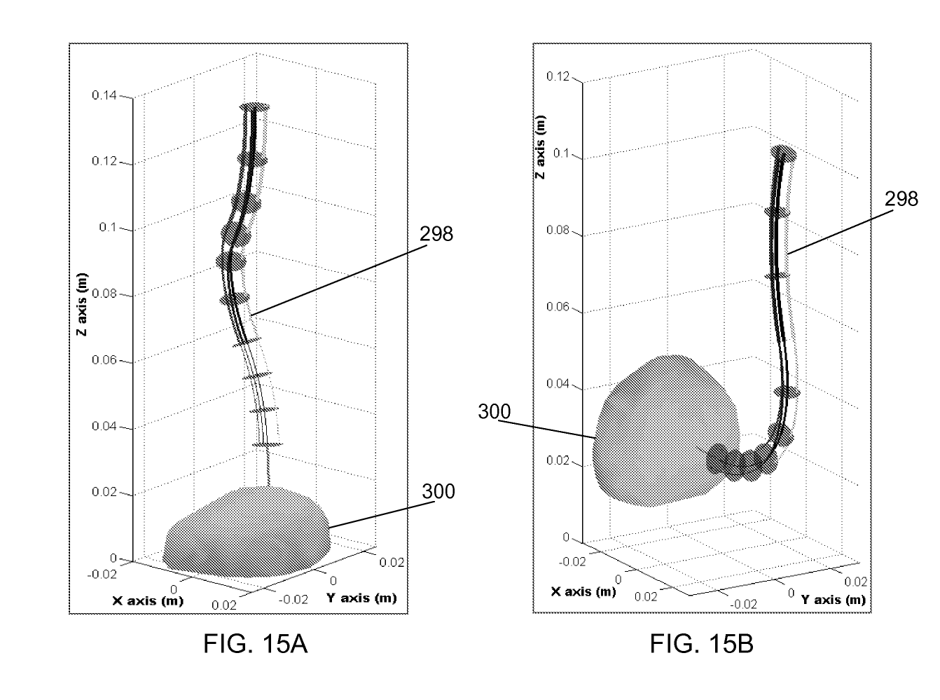

A simulation can be useful in evaluating the performance of a robot because the matrix (Jₙₓ^{T})⁺J_{nq}^{T} can vary throughout the workspace. In some embodiments, the simulation can be the palpitation of the upper surface of a digitized life-size prostate. The performance index can be evaluated using predefined palpation points in which the palpation direction is the same as the surface normal at the palpation point. Since the palpation only specifies a motion of five degrees of freedom while the 3-segment continuum robot has six degrees of freedom, an optimization can be implemented in the simulation to minimize the performance index. FIG. 15A illustrates a 3-segment continuum robot 298 palpating a prostate 300 from the top in accordance with some embodiments. In simulating the 3-segment continuum robot 298, the performance index of the surface scanned from the top ranged from 0.23 to 0.76. FIG. 15B illustrates a 3-segment continuum robot 298 palpating a prostate 300 from the side in accordance with some embodiments. The performance index of the surface scanned from the side ranged from 0.21 to 0.73. A performance index value of 0.2 can reduce the error from joint measurements by 5 times when the force is calculated for the distal end of the robot. For example, force sensors with a resolution of ±5 grams in measuring force at a joint, such as a backbone, can generate sensing results with a resolution of ±1 gram. The parameters of the 3-segment continuum robot used in the simulation are provided in table 6.

TABLE 6
Parameters of 3-Segment Continuum Robot

| | |
|---|---|
| r = 3.0 mm | Eₚ = Eₛ = 62 GPa |

| | | |
|---|---|---|
| L₍₁₎ = 50 mm | d₍₁₎ₒₚ = d₍₁₎ₛₒ = 0.889 mm | d₍₁₎ₚᵢ = d₍₁₎ₛᵢ = 0.762 mm |
| L₍₂₎ = 40 mm | d₍₂₎ₒₚ = d₍₂₎ₛₒ = 0.635 mm | d₍₂₎ₚᵢ = d₍₂₎ₛᵢ = 0.508 mm |
| L₍₃₎ = 30 mm | d₍₃₎ₒₚ = d₍₃₎ₛₒ = 0.406 mm | d₍₃₎ₚᵢ = d₍₃₎ₛᵢ = 0 mm |

| | | |
|---|---|---|
| κ₍₁₎ = 1.076 | κ₍₂₎ = 1.075 | κ₍₃₎ = 1.132 |
| θ_{(1)c} = 7.2° | θ_{(2)c} = 7.3° | θ_{(3)c} = 12.7° |

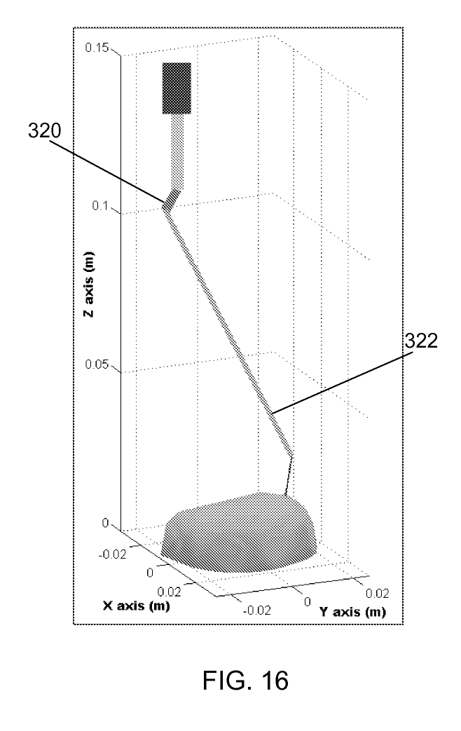

FIG. 16 illustrates a Stanford manipulator robot palpating a prostate from the top in accordance with certain embodiments. In order to evaluate the Stanford robot effectively, the robot can be scaled to have similar dimensions to the 3-segment continuum robot. This scaling can occur because the Jacobian matrices are not normalized before the index is evaluated, so without the scaling a comparison could be difficult. In FIG. 16 the Stanford manipulator can be designed to include a d₂ 320 value of 20 mm and a d₃ 322 value that can vary from 90 to 120 mm. In some embodiments, in order to avoid singularity in the palpation task d₃ 322 is placed above the prostate model with a 50 mm offset. The performance indices for these two types of robots are evaluated as the following in equation 56 and 57.

χ_{Stewart}=∥J_{(Stewart)qx}^{T}∥_{F} (56)

χ_{Stanford}=∥(J_{(Stanford)xq}^{T})⁺∥_{F} (57)

Equation 56 can be further defined with J_{(Stewart)qx}\dot{x}=\dot{q} and equation 57 with \dot{x}=J_{(Stanford)xq}\dot{q}. For the Stanford manipulator, the performance index varied from 16.2 to 31.5, in certain embodiments. This can mean for a Stanford manipulator that the force measurement errors at the joints can be magnified twenty times into the force sensing results.

The force sensing can be used in surgical and diagnostic applications that use force feedback in confined spaces, such as minimally invasive surgery of the throat and upper airways. The continuum robot can also be used in MRI diagnostic and surgical procedures, such as in neurosurgery, and can be used for such tasks as moving or stimulating parts of the brain. In some embodiments, the continuum robot can be used for other minimally invasive surgeries and procedures such as general micro-surgery, ear, nose and throat surgery, sinus surgery, other head and neck surgery, spinal surgery, micro-vascular surgery, bone surgery, tumor detection, tumor removal, diseased tissue detection, ultra-sound procedures, and drug delivery. Drug delivery by the robot can include delivery of medication, antibiotics, antibacterials, antiproliferatives, neuroprotectives, anti-inflamatories, growth factors, neutropic factors, antiangiogenics, thromobolytics, and genes.

The force sensing presented above can be used with many different robot configurations with slight modifications to the equations to account for the number of backbones, any tool on the end effector, and/or a robot using multiple independent sections. The continuum robot using multiple backbones in push-pull actuation can offer some advantages over the wire-actuated snake-like robots, such as backlash elimination, enhanced down-scalability, and improved payload.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways within the scope and spirit of the invention. While certain embodiments have been described here, other embodiments are within the scope of the appended claims. For example, the continuum robot may be covered with an elastic sheathing to ease insertion and removal of the device.

We claim:

1. A system for force sensing in a robot comprising:
an end disk;
a plurality of backbones coupled to the end disk;
a plurality of spacer disks dispersed along the plurality of backbones and keeping the plurality of backbones separated from one another;
a base disk, which provides an interconnection point to a lumen, wherein the lumen provides a channel to an actuation device;
the actuation device providing actuation of the backbones;
at least one sensor that measures the force being applied on one of the plurality of backbones; and
a processor receiving force measurements from the at least one sensor and determining the displacement of at least one of the plurality of backbones.

2. The system of claim 1, wherein the processor calculates the force and moment of the end disk based on the force measurements and displacement of at least one of the plurality of backbones.

3. The system of claim 1, further comprising:
a tool coupled to the end disk; and
the processor calculating the force and moment of the tool based on the force measurements and displacement of at least one of the plurality of backbones.

4. The system of claim 1, wherein the processor calculates the force and moment of a distal end of the robot using the force measurements and displacement of at least one of the plurality of backbones in a single segment and known conditions.

5. The system of claim 4, further comprising fiber optic based vision, wherein the fiber optic cable is provided within a backbone, and the known conditions is sensory information obtained from the fiber optic based vision.

6. The system of claim 1, wherein the force measurements and displacement of at least one of the plurality of backbones is merged with tracking information about the robot and the processor uses the merged information to calculate the force and moment at a distal end of the robot.

7. The system of claim 1, wherein the at least one sensor is a fiber Bragg Grating optical sensor and a fiber optic cable is inserted within at least one of the plurality of backbones.

8. The system of claim 1, wherein the end disk, the spacer disks, and the backbones are manufactured with magnetic resonance imaging (MRI) compatible materials.

9. The system of claim 1, wherein the processor calculates the force measurements and the displacement of one of the plurality of backbones to determine the stiffness of a tissue.

10. The system of claim 1, wherein measurements of the stiffness of a tissue are used to determine if the tissue is diseased.

11. The system of claim 1, wherein the robot is composed of three independently controlled segments.

12. A method of force sensing in a robot that has an end disk coupled with a plurality of backbones where the backbones pass through a plurality of spacer disks, the method comprising:
measuring the force applied on a first and a second backbone of the plurality of backbones using at least one sensor;
measuring the displacement of the first and the second backbone of the plurality of backbones using at least one sensor; and
receiving the force applied on the first and the second backbone and the displacement of the first and the second backbone at the processor.

13. The method of claim 12, further comprising calculating the force and moment at a distal end of the robot using the force applied and the displacement of the first and the second backbones.

14. The method of claim 13, further comprising sending force feedback information from the processor based on the force calculated at the distal end of the robot.

15. The method of claim 13, further comprising calibrating the calculations performed in the processor based actual measurements of the robot.

16. The method of claim 12, wherein the distal end of the robot is a tool coupled to the end disk.

17. The method of claim 12, further comprising delivering a drug through one backbone of the plurality of backbones.

18. The method of claim 12, further comprising capturing image information from a fiber optic camera integrated with the robot.

19. The method of claim 12, further comprising calculating the force and moment at the distal end of a single segment robot using the force applied and the displacement of the first and the second backbones and known conditions.

20. The method of claim 12, further comprising:
probing tissue with the distal end of the robot;
receiving measurements from the at least one sensor at the processor and calculating the measurements to determine stiffness of the tissue.

21. The method of claim 12, wherein the at least one sensor is a fiber Bragg Grating optical sensor and a fiber optic cable is inserted within at least one of the plurality of backbones.

22. A system for force sensing in a robot comprising:
end means for coupling a plurality of flexible means;
flexible means for providing stiffness in the axial direction while providing bending flexibility;
spacer means for separating the plurality of flexible means from one another;
base means for interconnecting with a lumen;
actuation means for providing actuation of the plurality of flexible means;
sensing means for measuring the force being applied on one of the plurality of flexible means; and
processor means for determining the displacement of at least one of the plurality of flexible means and receiving force measurements from the sensing means.

23. An apparatus for force sensing in a robot comprising:
an end disk;
a first joint with a proximal end and a distal end, wherein the distal end is coupled to the end disk;
a second joint with a proximal end and a distal, wherein the distal end is coupled to the end disk;
a sensor coupled with the first joint, wherein the sensor measures the force placed upon the first joint;
an actuation device coupled to the first joint, wherein the actuation device moves the joint;
a processor in operative communication with the sensor and the actuation device, wherein the processor receives a force measurement of the force placed upon the first a joint and a displacement measurement of the position of the proximal end of the first joint, and the processor calculates the force acting upon a distal end of the robot.

24. The apparatus of claim 23, wherein the distal end of the robot is a tool attached to the end disk.

25. The apparatus of claim 23, wherein the first joint is a backbone.
